(19) United States
(12) Patent Application Publication
(10) Pub. No.: US 2010/0217762 A1
(43) Pub. Date: Aug. 26, 2010

(54) INFORMATION PROVIDING SYSTEM, INFORMATION SIGNAL PROCESSING DEVICE, INFORMATION SIGNAL PROCESSING METHOD AND RECORDING MEDIUM

(75) Inventors: Yusuke Kajio, Tokyo (JP); Tetsujiro Kondo, Tokyo (JP); Kazutaka Ando, Kanagawa (JP); Yoshihiro Takahashi, Chiba (JP); Toru Nakagawa, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Sony Corporation, Tokyo (JP)

(21) Appl. No.: 12/739,419

(22) PCT Filed: Oct. 27, 2008
(86) PCT No.: PCT/JP2008/069476

§ 371 Date: May 3, 2010

(30) Foreign Application Priority Data
Nov. 2, 2007 (JP) 2007-286452

(51) Int. Cl. G06F 17/30

(52) U.S. Cl. 707/723; 707/E17.014

(57) ABSTRACT

Information is supplied to a user, the information regarding operations performed by other users.

According to the present invention, a remote control device 200 which have a plurality of commands corresponding to a plurality of functions and which performs data communication with a server 300 includes an command display/input unit 17 which displays text blocks corresponding to the commands and generates, when an operation of a selection of one of the displayed commands is accepted, a signal corresponding to the command and outputs the signal. The remote control device 200 further includes an association degree calculating unit which calculates association degrees of first commands which have been selected the last times and second commands which have selected by operation inputs performed using an operation unit and which assigns ranks in order of association degree. Then, the commands are displayed in the command display/input unit 17 in order of the assigned ranks.

### TECHNICAL FIELD

The present invention relates to information presentation systems, information signal processing apparatuses, information signal processing methods, and recording media, and particularly relates to an information presentation system capable of extracting, on the basis of history information regarding operations of a user, information on an operation performed by another user who has a preference similar to the user, and providing the extracted information to the user, an information signal processing apparatus, an information signal processing method, and a recording medium.

### BACKGROUND ART

Conventionally, in reproducing apparatuses and recording/reproducing apparatuses, for example, setting items used to control an image quality may be selected from a menu, and the items are generally configured as a hierarchical structure. When a desired setting item is to be selected from such a hierarchical menu, an operation of pressing a button is required to be performed several times. FIG. 1 shows, as an example of the hierarchical menu, an image quality control menu in a reproducing apparatus.

In FIG. 1, among items “image control 1”, “image control 2”, “scene mode”, and “various settings”, the item “image quality control 2” is selected, and among items in an immediately lower layer, an item “color density” is selected by a cursor CS10.

As means for vertically and horizontally moving the cursor CS10, a remote control device 20 shown in FIG. 2 is used. The remote control device 20 includes an arrow key KY, a back button XB used to instruct an operation of returning to a screen or an item which has been previously displayed, and an enter button XA used to determine an operation. Then, the arrow key KY includes an up button XU used to move the cursor CS10 upward, a right button XR used to move the cursor CS10 rightward, a down button XD used to move the cursor CS10 downward, and a left button XL used to move the cursor CS10 leftward.

When a menu screen MN10 in a state as shown in FIGS. 1(a) to 1(c) is displayed, that is, when a user wishes to select an item “detailed control” in a state in which the item “color density” has been selected, first, the back button XB shown in FIG. 2 is pressed once so that the state in which the item “color density” has been selected is cancelled, and the down button XD is pressed four times so that the item “detailed control” is pointed by the cursor CS10, and thereafter, the enter button XA is finally pressed so that the selection is determined. Therefore, six pressing operations are required in total.

Even when the user selects the item “detailed control” almost every time after the user selects the item “color density”, the total six pressing operations are required when the selection is changed between the two menu items. Therefore, a method for changing a user interface depending on a user's preference has been employed, for example.

Japanese Unexamined Patent Application Publication No. 6-75729 discloses a method for changing commands to be displayed as options depending on a tendency of command selections by a user.

However, although a user interface suitable for the tendency of user's selections is used when the method disclosed in Patent Document 1 is employed, means for determining whether a selection operation is appropriate by the user has not been proposed. Taking a case where an image quality control is performed as shown in FIG. 1 as an example, it is considered that, when wishing to obtain a certain image quality, the user performs operations on the menu so that the desired image quality is obtained as much as possible. However, it is not necessarily the case that the operations and values set in accordance with the operations are optimum in terms of a degree of realization of the image quality, operation efficiency, and the like. Other more efficient or effective methods for selecting items to be set, values to be set, and an order of selections of items may be employed in order to obtain the desired image quality. However, since the user does not have means for obtaining the information, there arises a problem in that the user merely performs settings by a method that the user thought of.

The present invention has been made in view of the above problem, and an object is to provide information on a user's operation to another user.

### DISCLOSURE OF INVENTION

According to the present invention, an information signal processing apparatus which has a plurality of commands corresponding to a plurality of functions and which performs data communication with a server includes an operation unit which accepts operation inputs and generates signals in accordance with a number of the commands selected by the operation input, and a command display/input unit which is included in the operation unit, which displays text blocks corresponding to the commands, and which generates and outputs signals corresponding to the commands when accepting the selection operations of the commands corresponding to the text blocks. The information signal processing apparatus further includes an operation history storage unit which stores content of the operation inputs performed using the operation unit so as to generate operation history information, and a command association degree calculating unit which calculates degrees of associations between first commands in which selection operations thereof were accepted last time and second commands which are selected by the operation inputs using the operation unit for individual combinations of the first commands and the second commands, and which assigns ranks to the second commands associated with the first commands in ascending order of degrees of the associations with the first commands so as to generate first display ranking information. Moreover, the information signal processing apparatus includes an input/output unit which outputs the operation history information stored in the operation history storage unit and the first display ranking information to the server and receives second display ranking information output from the server, and a display-command extracting unit which selects one of the first commands of a type the same as the command selected by the input operation using the operation unit from at least one of display ranking information selected by a user from among the first display ranking information and the second display ranking information, which extracts a predetermined number of second commands which are associated with the selected first command in the display ranking information in ascending order of degrees of associations with the first command, and which outputs the extracted second commands. With this configuration, the command display/input unit displays the text blocks corresponding to the predetermined number of second commands output from the display command extracting unit in ascending order of the ranks assigned to the second command.

Accordingly, the second display ranking information generated by the server in accordance with operation history information of a plurality of users and display ranking information calculated in accordance with operation histories is supplied to the user.

According to the present invention, a user obtains information on operations performed by other users.

### BRIEF DESCRIPTION OF DRAWINGS

FIG. 1 shows diagrams illustrating display of a conventional menu screen wherein FIG. 1(a) shows a state in which an item “color density” is selected, FIG. 1(b) shows a state in which an item “image quality control 2” is selected, and FIG. 1(c) shows a state in which an item “detailed control” is selected.

FIG. 2 is an appearance diagram illustrating a configuration of a conventional remote control device.

FIG. 3 is an explanatory diagram illustrating an outline of a system according to a first embodiment of the present invention.

FIG. 4 is a block diagram illustrating an internal configuration of the system according to the first embodiment of the present invention.

FIG. 5 is an appearance diagram illustrating a configuration of a remote control device according to the first embodiment of the present invention.

FIG. 6 is a function block diagram illustrating a function of the remote control device according to the first embodiment of the present invention.

FIG. 7 is an explanatory diagram illustrating operation history information according to the first embodiment of the present invention.

FIG. 8 is an explanatory diagram illustrating operation history information according to the first embodiment of the present invention.

FIG. 9 is an explanatory diagram illustrating a configuration of a questionnaire according to the first embodiment of the present invention.

FIG. 10 is a flowchart of an example of a process performed by a command storage determination unit according to the first embodiment of the present invention.

FIG. 11 is a flowchart of an example of a process performed by an input-frequency calculating unit according to the first embodiment of the present invention.

FIG. 12 is an explanatory diagram illustrating frequency ratios according to the first embodiment of the present invention.

FIG. 13 is a flowchart of an example of a process performed by a shifting speed calculating unit according to the first embodiment of the present invention.

FIG. 14 is an explanatory diagram illustrating shifting speeds according to the first embodiment of the present invention.

FIGS. 15(a) and 15(b) are explanatory diagrams illustrating associations between a command selection time and a command association degree according to the first embodiment of the present invention.

FIGS. 16(a) and 16(b) are explanatory diagrams illustrating associations between the number of times operations are performed when a command is changed to another command and a command association degree.

FIG. 17 is a flowchart of an example of a process performed by a command-association-degree calculating unit according to the first embodiment of the present invention.

FIG. 18 is an explanatory diagram illustrating display ranking according to the first embodiment of the present invention.

FIG. 19 is an explanatory diagram illustrating display ranking according to the first embodiment of the present invention.

FIG. 20 is a flowchart of an example of a process performed by a display-command extracting unit according to the first embodiment of the present invention.

FIG. 21 is a flowchart of an example of a process performed by the display-command extracting unit according to the first embodiment of the present invention.

FIG. 22 is a table of an example of display ranking according to the first embodiment of the present invention.

FIG. 23 is an explanatory diagram illustrating display of a menu screen according to the first embodiment of the present invention.

FIG. 24 is a flowchart of an example of a process of updating the display ranking according to the first embodiment of the present invention.

FIG. 25 is a flowchart of an example of a process performed when storage information is obtained from the remote control device according to the first embodiment of the present invention.

FIG. 26 is a function block diagram illustrating a function of a server according to the first embodiment of the present invention.

FIG. 27 is an explanatory diagram illustrating a result of a log-data process according to the first embodiment of the present invention.

FIG. 28 is an explanatory diagram illustrating division according to levels of operation amounts according to the first embodiment of the present invention.

FIG. 29 is an explanatory diagram illustrating community classification parameters according to the first embodiment of the present invention.

FIG. 30 is an explanatory diagram illustrating classification into communities according to the first embodiment of the present invention.

FIG. 31 is an explanatory diagram illustrating an outline of a process of determining community display ranking according to the first embodiment of the present invention.

FIG. 32 is an explanatory diagram illustrating the community display ranking according to the first embodiment of the present invention.

FIG. 33 is a flowchart of an example of a process performed by a master-user extracting unit according to the first embodiment of the present invention.

FIG. 34 is an explanatory diagram illustrating storage of the community display ranking according to the first embodiment of the present invention.

FIGS. 35(a) to 35(c) are explanatory diagrams illustrating display in a display unit according to the first embodiment of the present invention.

FIG. 36 is an explanatory diagram illustrating an outline of a system according to a second embodiment of the present invention.

FIG. 37 is an appearance diagram illustrating a configuration of a cellular phone terminal according to the second embodiment of the present invention.

FIG. 38 is a block diagram illustrating an internal configuration of the cellular phone terminal according to the second embodiment of the present invention.

FIG. 39 is a function block diagram illustrating a function of the cellular phone terminal according to the second embodiment of the present invention.

FIG. 40 is an explanatory diagram illustrating input-character history data according to the second embodiment of the present invention.

FIG. 41 is an explanatory diagram illustrating frequency ratios according to the second embodiment of the present invention.

FIG. 42 is an explanatory diagram illustrating shifting speeds according to the second embodiment of the present invention.

FIG. 43 is an explanatory diagram illustrating display ranking according to the second embodiment of the present invention.

FIG. 44 is an explanatory diagram illustrating a configuration of a questionnaire according to the second embodiment of the present invention.

FIG. 45 is an explanatory diagram illustrating a result of a log-data process according to the second embodiment of the present invention.

FIG. 46 is an explanatory diagram illustrating community classification parameters according to the second embodiment of the present invention.

FIG. 47 is an explanatory diagram illustrating settings of threshold values used for classification of communities according to the second embodiment of the present invention.

### BEST MODES FOR CARRYING OUT THE INVENTION

### First Embodiment

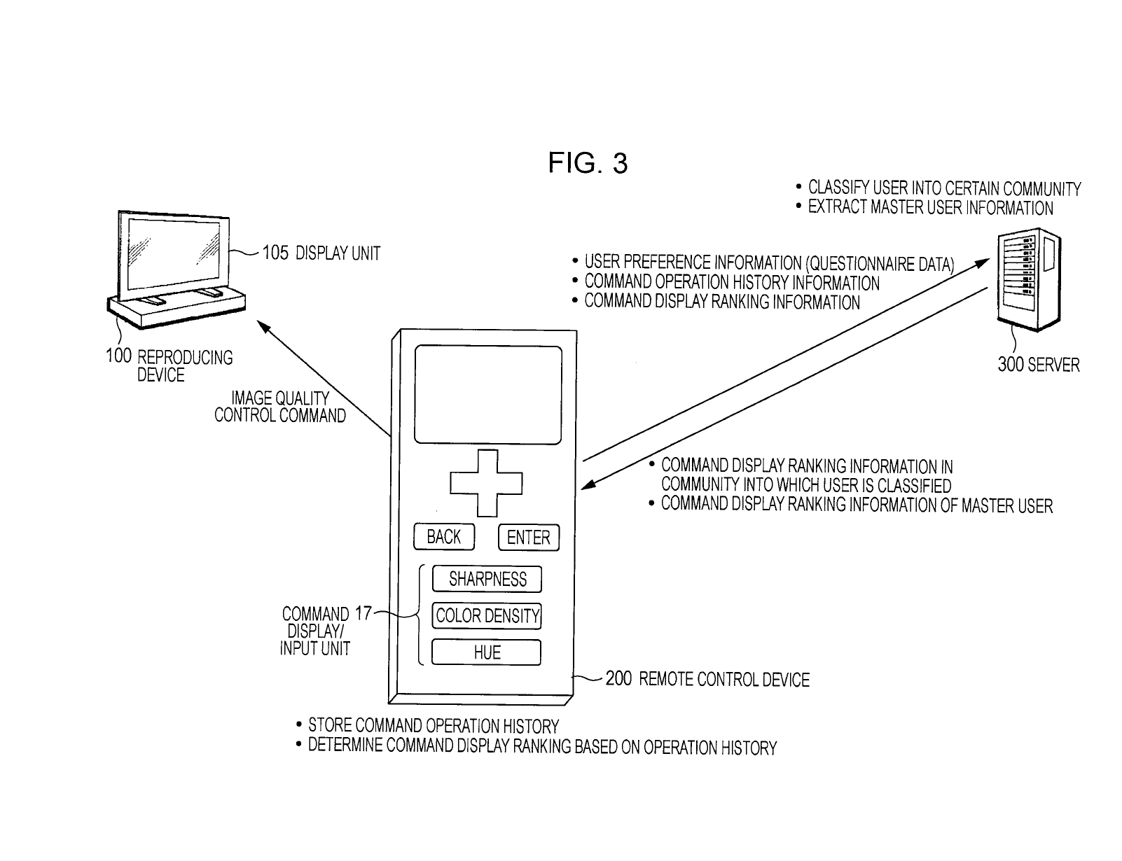

A first embodiment of the present invention will be described hereinafter with reference to FIGS. 3 to 35. FIG. 3 shows an outline of an information presentation system of this embodiment. This system includes a reproducing device 100, a remote control device 200, and a server 300. The remote control device 200 is an example of an information signal processing apparatus of the present invention.

The reproducing device 100 from which an external storage medium such as an HDD (Hard Disk Drive) and a DVD (Digital Versatile Disc) drive is detachable reproduces video content and the like recorded in such a device. The remote control device 200 transmits a command for instructing reproduction or stop of a video image to the reproducing device 100 in response to a user's operation, and in addition, outputs a command for image quality control. When a user performs image quality control through the remote control device 200, information on history of the operation is stored in the remote control device 200.

The remote control device 200 stores a history of user's operations and extracts a command which is the most highly associated with a command input by the user (or a command which is most likely selected next by the user) in accordance with information on the stored operation history. Then, the extracted command is displayed in a command display/input unit 17. Here, the command represents a function such as “sharpness” or “color density”, for example. The command display/input unit 17 functions also as a command button. When accepting a pressing operation performed by the user, the command display/input unit 17 generates a signal corresponding to a command displayed in the pressed command button and outputs the signal.

In this embodiment, since the command display/input unit 17 includes three buttons, three commands are extracted in accordance with a command (hereinafter also referred to as an “input command”) input by the user. The extracted commands are assigned to the buttons in order of degrees of associations with the input command from the uppermost portion. The commands are assigned in accordance with information on command display ranking which has been calculated in advance. The command display ranking is determined on the basis of degrees of associations between commands calculated in accordance with the operation history.

The remote control device 200 displays a questionnaire used to obtain information on a user's preference, and accepts input of answers of the user at the time of an initial setting of the device. Information on the questionnaire obtained here and the operation history information and the command-display-ranking information stored in the remote control device 200 itself are individually supplied to the server 300. The server 300 extracts information (command-display-ranking information) which may be highly usable for the user using the remote control device 200 in accordance with the information supplied from the remote control device 200, and supplies the information to the user.

Examples of the information which may be highly usable for the user include information on operations performed by another specific user (hereinafter referred to as a “master user”) such as a specialist of video production or a movie critic in which it is highly possible that content of the operation may be of some help for the user or information on operations performed by a still another user which has a preference similar to that of the user. In this embodiment, the command display ranking determined on the basis of operation histories of such a user is supplied to the user.

The extraction of another user who has a preference similar to the preference of the user is performed in accordance with community information stored in the server 300. Community means a group in which users who have similar preferences are gathered, and the server 300 performs classification in accordance with questionnaire information supplied from the users and operation history information.

When receiving information supplied from a user, the server 300 performs a process of classifying the user who supplied the information into one of communities and transmitting command-display-ranking information in the classified community and command-display-ranking information of a master user to the user.

Through this process, information on operations performed by other users which may be highly usable for the user is supplied to the user.

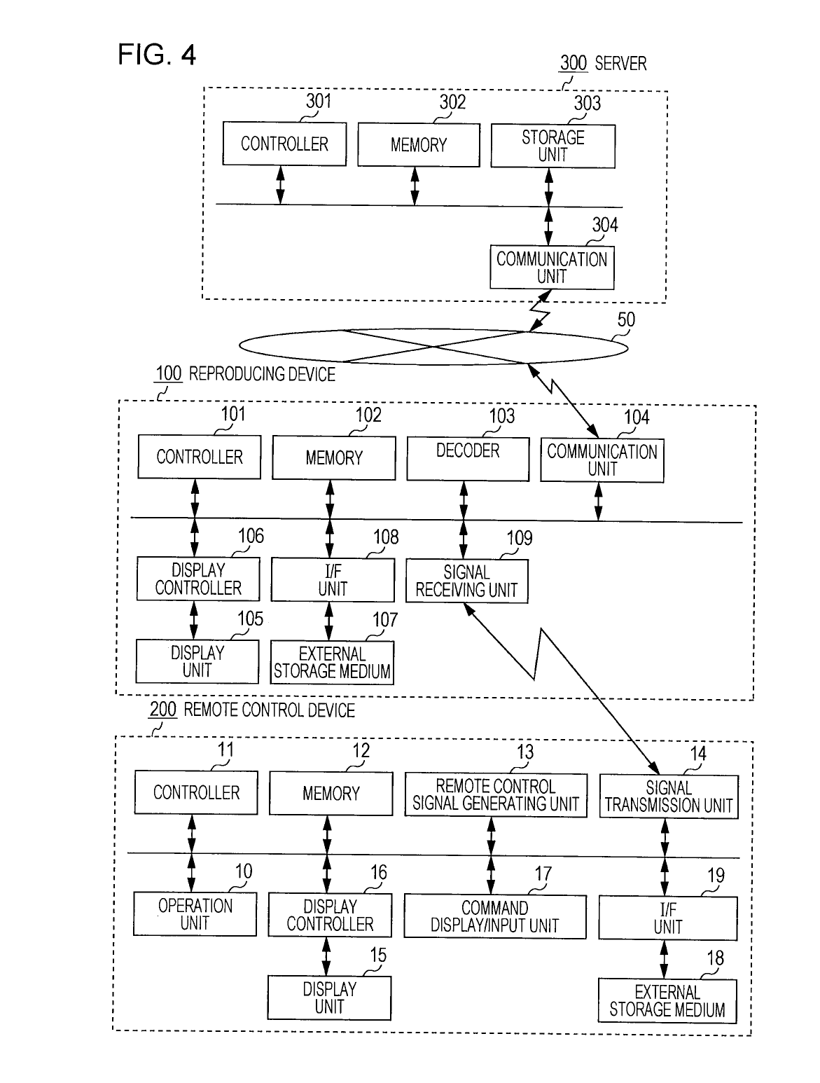

Next, an example of an internal configuration of the information presentation system of this embodiment will be described with reference to FIG. 4. In FIG. 4, the reproducing device 100 and the server 300 are connected to each other through a network 50. Furthermore, each of the reproducing device 100 and the remote control device 200 is configured such that an external storage medium is detachable. Information stored in the remote control device 200 is first transmitted to the reproducing device 100 through the external storage medium and further transmitted to the server 300 through the network 50. Moreover, information stored in the server 300 is similarly transmitted to the remote control device 200 through the reproducing device 100.

Note that, although the remote control device 200 and the server 300 perform data communication through the reproducing device 100 in this embodiment, a method for performing data communication between the remote control device 200 and the server 300 is not limited to this. For example, an external storage medium which records the information stored in the remote control device 200 may be sent to the server 300 by mail, for example. Alternatively, in a case where the server 300 has an interface which enables wireless data communication with the remote control device 200, transmission/reception of data may be directly performed between the remote control device 200 and the server 300.

In FIG. 4, the server 300 includes a controller 301, a memory 302, a storage unit 303, and a communication unit 304. The controller 301 includes a CPU (Central Processing Unit) and the like, and the memory 302 includes a ROM (Read Only Memory) and a RAM (Random Access Memory). The controller 301 executes various processes in accordance with programs stored in the memory 302 or programs read from the storage unit 303 to the memory 302. The memory 302 stores data required for executing the various programs by the controller 301. The storage unit 303 includes an HDD and the like, and stores information on communities, information on master users, and information on display ranking of commands supplied from various users. The communication unit 304 is connected to the network 50, and controls transmission/reception of data transmitted through the network 50.

The reproducing device 100 includes a controller 101, a memory 102, a decoder 103, a communication unit 104, a display unit 105, a display controller 106, an external storage medium 107, an I/F (interface) unit 108, and a signal receiving unit 109. The controller 101, the memory 102, and the communication unit 104 are configured so as to be the same as those of the server 300, and therefore, descriptions thereof are omitted. The decoder 103 decodes a video signal which has been coded in accordance with the MPEG (Moving Picture Experts Group) standard, for example, and performs a process of extracting a baseband signal.

The display unit 105 is constituted by a CRT (Cathode-Ray Tube), an LCD (Liquid Crystal Display), or the like, and displays video content and the like under control of the display controller 106. The display controller 106 also performs an OSD (On Screen Display) process for displaying an image quality control menu, for example, in a screen of the display unit 105 in accordance with a command input from the remote control device 200.

The external storage medium 107 is constituted by an HDD, a DVD drive, a floppy disk (registered trademark), a memory card, or the like. The I/F unit 108 controls writing of data to and reading of data from the external storage medium 107. The signal receiving unit 109 receives a remote control signal transmitted from the remote control device 200, generates an operation signal corresponding to the remote control signal, and supplies the operation signal to the controller 101.

The remote control device 200 includes an operation unit 10, a controller 11, a memory 12, a remote control signal generating unit 13, a signal transmission unit 14, a display unit 15, a display controller 16, the command display/input unit 17, an external storage medium 18, and an I/F unit 19. The controller 11 is configured similarly to those of the server 300 and the reproducing device 100, and therefore, a description thereof is omitted. The memory 12 stores programs and data required for calculating association degrees between commands.

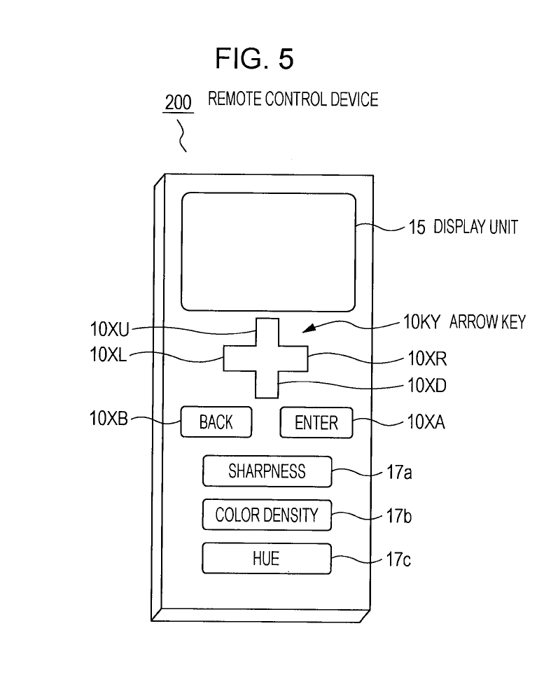

The operation unit 10 includes character input buttons and an arrow key, for example, and outputs an operation signal in accordance with a user's input operation. The operation unit 10 will be described in detail hereinafter with reference to FIG. 5. The remote control signal generating unit 13 generates a remote control signal on the basis of the operation signal output from the operation unit 10 or the command display/input unit 17, and outputs the remote control signal to the transmission unit 14. The remote control signal transmission unit 14 transmits the remote control signal generated by the remote control signal generating unit 13 to the reproducing device 100.

The display unit 15 is constituted by an LCD or the like, and displays a list of display ranks of commands which is to be obtained by the user, which will be described hereinafter, in accordance with a user's operation performed using the operation unit 10. The display controller 16 performs control of display of text and video images in the display unit 15. The command display/input unit 17 displays notations (names) representing various commands output from a display command extracting unit which will be described hereinafter. When the buttons included in the command display/input unit 17 are pressed by the user, signals corresponding to the displayed commands are output. The external storage medium 18 is constituted by a floppy disk (registered trademark) or a memory card, and stores information on answers of questionnaires, information on histories of user's operations, information on command display ranking and the like.

Next, referring to FIG. 5, an example of a configuration of the remote control device 200 will be described.

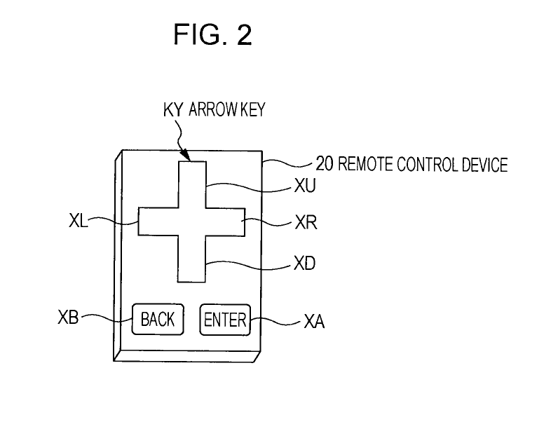

In the remote control device 200 shown in FIG. 5, an arrow key 10KY, a back button 10XB, and an enter button 10XA are configured so as to be the same as those of the conventional example shown in FIG. 2. The arrow key 10KY includes an up button 10XU, a right button 10XR, a down button 10XD, and a left button 10XL. The back button 10XB and the enter button 10XA are arranged below the arrow key 10KY. Further below the back button 10XB and the enter button 10XA, command display/input buttons 17a to 17c included in the command display/input unit are arranged.

The command display/input buttons 17a to 17c include respective display units constituted by LEDs (Light Emitting Diodes), for example, and changes text displayed in the display units in accordance with an operation input (input command) performed by the user. In the example shown in FIG. 3, “sharpness” is displayed in the command display/input button 17a, “color density” is displayed in the command display/input button 17b, and “hue” is displayed in the command display/input button 17c.

When the command display/input button 17a in which “sharpness” is displayed is pressed in accordance with a user's operation, a signal used to display a control screen for “sharpness” representing control of a degree of sharpness of images in a reproduced video image is transmitted to the reproducing device 100. Note that, although the command display/input unit 17 includes the buttons having a display function, the command display/input unit 17 may include a touch panel, for example.

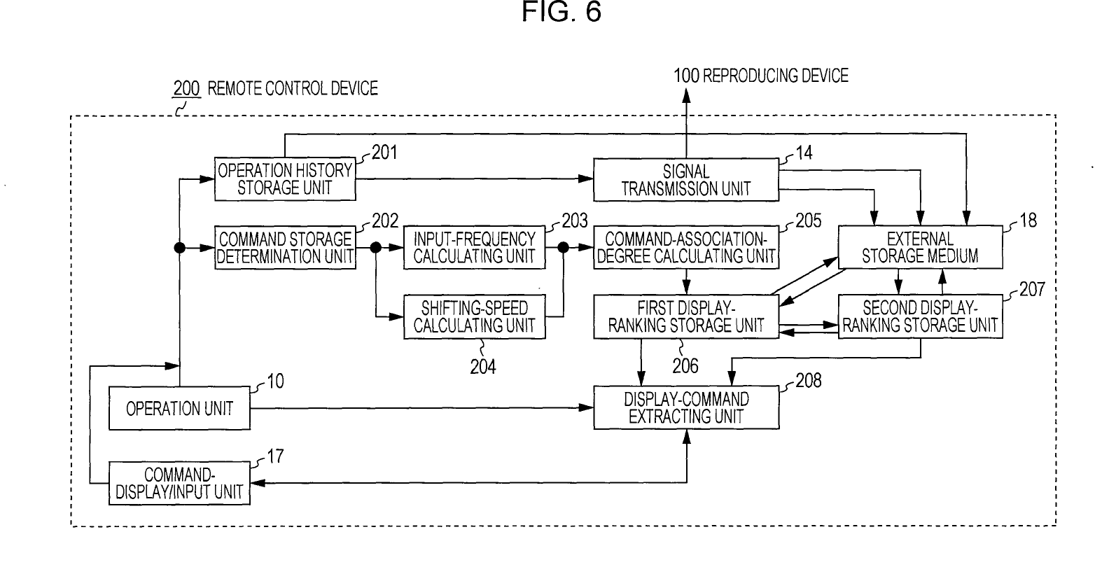

Next, operations of units included in the remote control device 200 will be described with reference to a function block diagram of FIG. 6. The remote control device 200 includes the operation unit 10, an operation history storage unit 201, a command storage determination unit 202, an input-frequency calculating unit 203, a shifting-speed calculating unit 204, a command-association-degree calculating unit 205, a first display-ranking storage unit 206, a second display-ranking storage unit 207, a display-command extracting unit 208, the signal transmission unit 14, the external storage medium 18, and the command display/input unit 17.

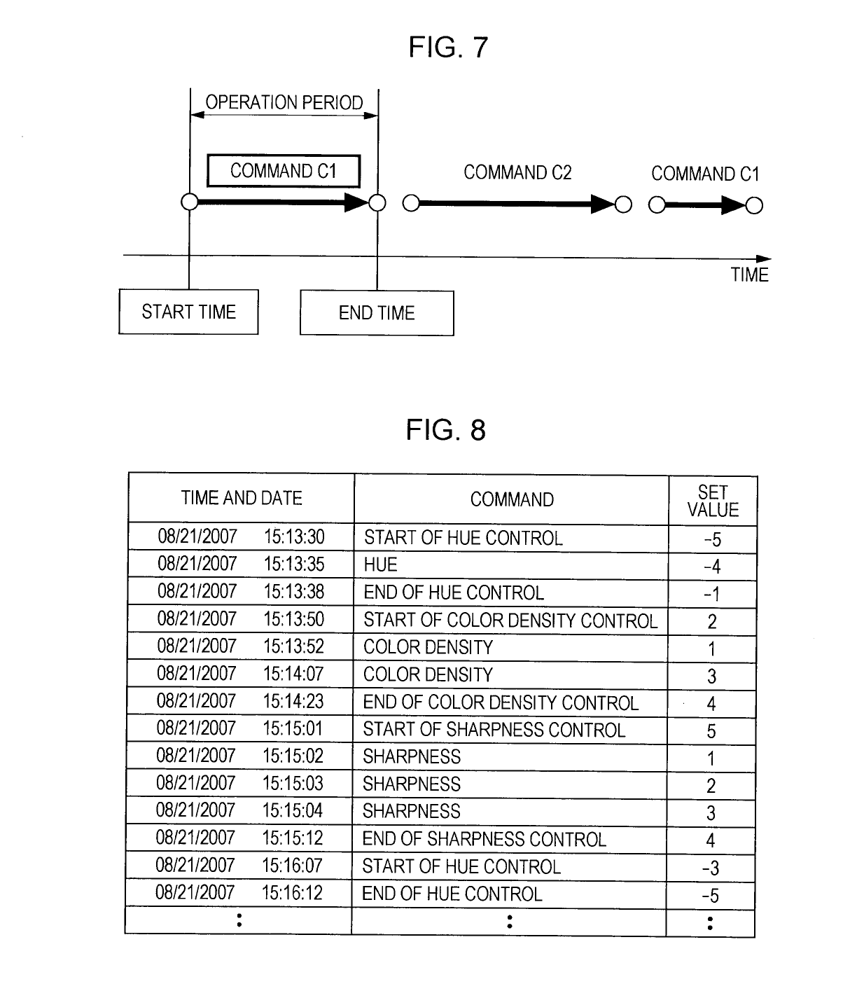

The operation history storage unit 201 is a region in which an entire history of operations performed using the operation unit 10 and the command display/input unit 17 is stored. Information stored in the operation history storage unit 201 is transmitted to the server 300 through the external storage medium 18, and is used by the server 300 as a criterion when the server 300 classifies users into communities. FIG. 7 shows an example of the operation history information. As the operation history information, information on a command type such as a command C1 or a command C2, information on a date and time when an operation of selecting a command is started and a date and time when the operation of selecting a command is ended, and information on values set when command operations are performed are obtained.

FIG. 8 shows an example of stored data of the operation history information. In columns of a date and time, dates and times when command operations are started and dates and times when the command operations are ended are described. In columns of a command, types of selected commands and information representing whether operations of the commands have been started or ended. Furthermore, values set at certain stages of the command operations are also described. A first row of FIG. 8 represents that a command “hue” is selected at 15:13:30 on Aug. 21, 2007, and a value set at this time, that is, a set value which has been determined by an operation performed immediately before this operation is “−5”. A second row represents that a value corresponding to “hue” is determined and set at 15:13:35 on the same day. A third row represents that a control operation corresponding to “hue” is terminated at 15:13:38 on the same day, and a value set at this time is “−1”.

Such operation history information is stored in the operation history storage unit 201 (refer to FIG. 4). The operation history information stored in the operation history storage unit 201 is output to the external storage medium 18 in a predetermined cycle, for example, every two months, or when a data storage amount in the operation history storage unit 201 reaches a predetermined amount which has been set in advance. Then, the information is transmitted to the server 300 through the reproducing device 100. A process of outputting data to the external storage medium 18 will be described in detail hereinafter.

In this embodiment, the server 300 uses the information on answers of questionnaires of users as a criterion for making a determination when the server 300 classifies the users into communities, and the information on answers of questionnaires is also stored in the operation history storage unit 201.

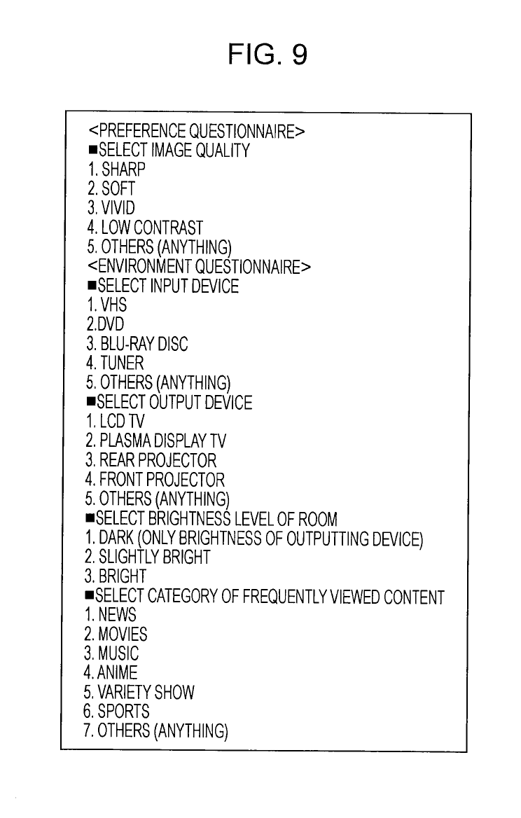

FIG. 9 shows an example of a configuration of a questionnaire. The questionnaire is stored in the memory 12, for example, included in the remote control device 200 in advance. When an initial setting is performed at a timing when the reproducing device 100 is first turned on, the questionnaire is displayed in the display unit 105 of the reproducing device 100 or the display unit 15 of the remote control device 200. Alternatively, when a user registration performed by a user is received through the Internet, for example, an input of information on answers of questionnaires may be received. The questionnaire shown in FIG. 9 includes a “preference questionnaire” used to obtain information on a preference of the user and an “environment questionnaire” used to obtain information on an environment of the user when the user views content.

As items of the preference questionnaire, a question about image quality is provided so that an answer “sharp”, an answer “soft”, or the like is selected. As items of the environment questionnaire, questions about types of an input device and an output device, a brightness level of a room, and a category of frequently-viewed content are provided. The information on answers of questionnaires stored in the operation history storage unit 201 is output to the external storage medium 18 simultaneously when the operation history information and the command display ranking information is output to the external storage medium 18.

Referring back to the function block diagram of FIG. 6, the command storage determination unit 202 determines whether a command input by the user is used for calculation of a degree of an association between commands, which will be described hereinafter. Specifically, when a command is selected using the operation unit 10 or the command display/input unit 17 and only when a period of time elapsed between a time point when an execution of a preceding command is terminated and a time point when the current command is received is equal to or smaller than a predetermined period of time, the command currently received is output to the input-frequency calculating unit 203. That is, only such a command is used for the calculation of a degree of an association between commands and other commands are not stored.

The command storage determination unit 202 performs a process of storing a time point when a selection of a preceding command is completed and a type of the command in order to obtain a period of time elapsed between a time point when the selection of the preceding command has been terminated and a time point when a command currently input is received. Note that the time point when a selection of a preceding command is completed corresponds to a time point when the back button 10XB is pressed in a state in which “sharpness” has been selected or a time point when a command selection state is cancelled by an operation of pressing a direct button, not shown, for example. Also in a case where the selection state is cancelled (the menu screen is cancelled) since a period of time in which any operation is not performed continues for a certain period of time after control of “sharpness” is performed, it is determined that the selection of a command is completed, and the time point of the completion of the command is stored. Note that the time point of the completion to be stored here is not a time point when a menu screen MN1 is cancelled but a time point when a set value is changed in accordance with the selection of the command.

The input-frequency calculating unit 203 calculates a frequency of occurrence of a case where a “preceding command” (first command) which is a command selected the last time and an “input command” (second command) which is a command currently input are consecutively input in terms of time. The shifting-speed calculating unit 204 calculates a speed of a shifting from the “preceding command” to the “input command” when the commands are changed from one to another through the user interface such as the menu screen. The shifting speed will be described in detail hereinafter.

The command-association-degree calculating unit 205 calculates a degree of an association between commands, that is, a combination of the “preceding command” and the “input command” in accordance with the input frequency calculated by the input-frequency calculating unit 203 and the shifting speed calculated by the shifting-speed calculating unit 204. Then, the command-association-degree calculating unit 205 performs a process of assigning ranks to such combinations of commands on the basis of calculated association degrees. The first display-ranking storage unit 206 is a region which stores the display ranks of the commands calculated as described above.

Note that the input frequency calculated by the input-frequency calculating unit 203, the shifting speed calculated by the shifting-speed calculating unit 204, and the degree of an association between commands calculated by the command-association-degree calculating unit 205 are obtained for each combination of the “preceding command” and the “input command” which are associated with each other, and results of the calculations are stored in the memory 12, for example. Commands corresponding to the “preceding command” and commands corresponding to the “input command” are changed on a case-by-case basis. For example, in a case where a command “color density” is input and a command “sharpness” is selected immediately before the command “color density, the command “sharpness” corresponds to the “preceding command” and the command “color density” corresponds to the “input command”. Furthermore, a command “color density” is input and a command “hue” is selected immediately before the command “color density”, the command “hue” corresponds to the “preceding command” and the command “color density” corresponds to the “input command”.

The second display-ranking storage unit 207 is a region which stores command display ranking and the like of other users or the master users transmitted from the server 300. Data stored in the second display-ranking storage unit 207 is prevented from being updated by a process performed by the command-association-degree calculating unit 205, for example. Therefore, the user moves information on the command display ranking stored in the first display-ranking storage unit 206 to the second display-ranking storage unit 207 whereby the information on the display ranking is retained. The user may make a determination as to whether the information on the display ranking stored in the first display-ranking storage unit 206 or the information on the display ranking stored in the second display-ranking storage unit 207 is used (or both of the information may be used).

As described above, since the display ranking information stored in the second display-ranking storage unit 207 is retained so as not to be updated, if the user wishes to store a plurality of display ranking information, a plurality of display-ranking storage units 207 may be provided. For example, in a case where a single reproducing device 100 is used by a plurality of persons such as members of a family, a plurality of display ranking information for the members of the family may be individually stored in a plurality of display-ranking storage units 207.

The display-command extracting unit 208 extracts, among combinations of the “preceding commands” and the “input commands” registered so as to be associated with each other which have been stored in the first display-ranking storage unit 206, three combinations which have higher association degrees calculated by the command-association-degree calculating unit 205 in order of association degree, and outputs the “input commands” of the extracted three combinations to the command display/input unit 17.

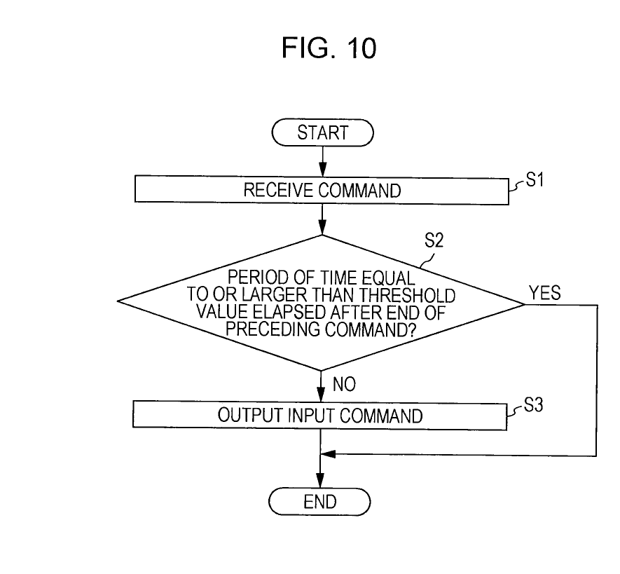

Next, operations of the units included in the remote control device 200 will be described in detail. First, an operation of the command storage determination unit 202 will be described with reference to FIG. 10. When receiving a command input using the operation unit 10 (step S1), the command storage determination unit 202 determines whether a period of time which has been elapsed from a time point when a selection of a preceding command is completed is equal to or larger than a threshold value (step S2). The threshold value corresponds to a predetermined period of time such as 30 seconds, and an arbitrary value may be set. When the period of time which has been elapsed from the time point when the selection of the preceding command is completed is equal to or larger than the threshold value, the process is terminated. When the period of time which has been elapsed from the time point when the selection of the preceding command is completed is smaller than the threshold value, a process of outputting the input command is performed (step S3).

By performing this process, a command input after a selection of a preceding command with a predetermined interval, for example, after a day has been elapsed, is not output from the command storage determination unit. That is, such a command is not used for calculation for obtaining a degree of an association with the preceding command.

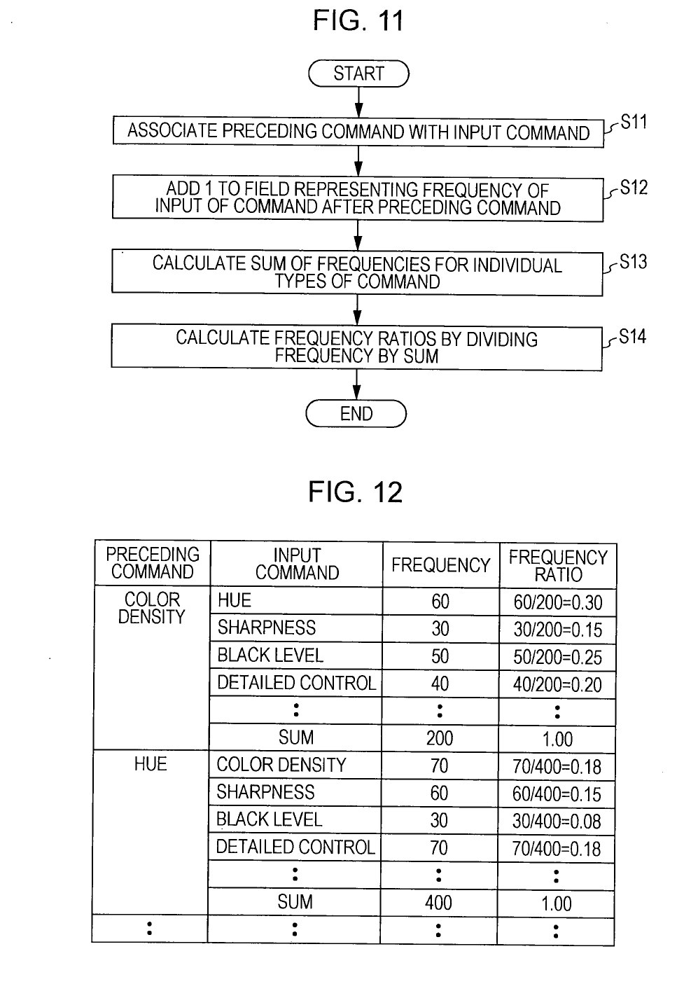

Next, an example of a process performed by the input-frequency calculating unit 203 will be described with reference to a flowchart shown in FIG. 11 and a table shown in FIG. 12. In FIG. 11, first, a command output from the command storage determination unit 202 is associated with a “preceding command” similarly stored in the command storage determination unit 202 (in step S11), and 1 is added to a field representing a frequency of an input of a combination of the output command and the “preceding command” (in step S12). Then, total values (frequencies) stored in fields representing frequencies are calculated for individual types of “preceding command” (in step S13), and frequency ratios are calculated by dividing values of the frequencies of the combinations of the “preceding commands” and the “input commands” by the corresponding total values which have been calculated (in step S14).

FIG. 12 shows examples of the frequency ratios of the combinations of “preceding commands” and “input commands”. As shown in FIG. 12, commands “hue”, “sharpness”, “black level”, “detailed control”, and the like are input after a command “color density” is executed, and commands “color density”, “sharpness”, “black level”, “detailed control” and the like are input after a command “hue” is executed.

Furthermore, a state in which different combinations of “preceding commands” and “input commands” have different frequency values such that a frequency of a selection of the command “hue” after the command “color density” is “60”, a frequency of a selection of the command “sharpness” after the command “color density” is “30”, and the like is shown. These values in a field “frequency” are obtained by addition of 1 performed in step S12 of the flowchart shown in FIG. 11. For example, in a case where the command “black level” is output from the command storage determination unit 202 and the command “hue” has been executed the last time, 1 is added to a field “frequency” corresponding to a condition in which the “preceding command” is the command “hue” and the “input command” is the command “black level”. That is, a frequency value is 31.

The input-frequency calculating unit 203 adds the frequency values to one another for the individual types of “preceding command” so as to obtain total values, and divides the individual frequency values by the corresponding total values whereby the “frequency ratios” are obtained (in step S13 and step S14 of FIG. 5). In the examples shown in FIG. 12, “input commands” corresponding to the command “color density” serving as the “preceding command” are the commands “hue”, “sharpness”, “black level”, “detailed control”, and the like, and a total value of frequencies thereof is 200. Then, since a frequency ratio of each of the combinations of “preceding commands” and “input commands” is calculated by dividing a frequency by a total value, when the “preceding command” corresponds to the command “color density” and the “input command” corresponding to the command “detailed control”, a frequency ratio of 0.20 is obtained by dividing 40 by 200. Furthermore, when the “preceding command” corresponds to the command “color density” and the “input command” corresponds to the command “black level”, a frequency ratio of 0.25 is obtained by dividing 50 by 200.

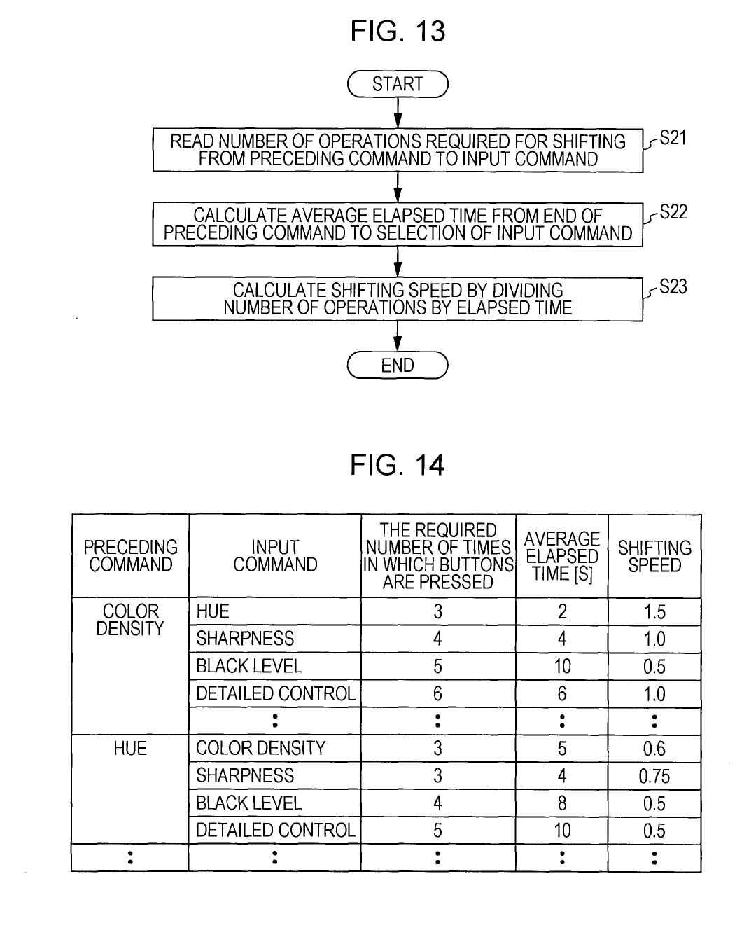

Next, an example of a process performed by the shifting-speed calculating unit 204 will be described with reference to a flowchart of FIG. 13. The shifting-speed calculating unit 204 first reads, from the external storage medium 18 or the like, the requisite minimum number of operations performed using the operation unit 10 required for inputting an “input command” after a state in which a “preceding command” has been selected (in step S21). Then, an average period of time elapsed from the state in which the “preceding command” has been selected to a state in which the “input command” is input is obtained (in step S22). Thereafter, the requisite minimum number of operations performed using the operation unit 10 is divided by the average elapsed time so that a shifting speed is obtained (in step S23).

The “average elapsed time” is calculated by obtaining a total elapsed time by adding a number of periods of time elapsed by the time the “input command” is input after a state in which the “preceding command” has been selected to one another, the number of periods of time corresponding to the predetermined number of measurements, and dividing the obtained total elapsed time by the number of measurements. In this case, as variables, the average elapsed time and the number of measurements which are obtained by the method described above are recorded. For example, assuming that the number of measurements is 10 and the average elapsed time obtained from 10 measurements is 3, and furthermore, a measurement value in the 11th measurement is 5 seconds, an average elapsed time of 3.18 (seconds/times) is obtained from the following equation: (10 (times)×3 (seconds/times)+5 (seconds))/11 (times)=3.18 (seconds/times).

Alternatively, combinations of a number of required actual periods of time elapsed by the time the “input command” is input after a state in which the “preceding command” has been selected and corresponding sequential numbers may be recorded, a sum of the periods of elapsed time may be calculated, and the sum of the periods of elapsed time may be divided by the number of measurements. In this case, as variables, the sequential numbers and the elapsed times are recorded. For example, assuming that the number of measurements is 5 and a result of the first measurement is 3 seconds, a result of the second measurement is 4 seconds, a result of the third measurement is 2 seconds, a result of the fourth measurement is 3 seconds, and a result of the fifth measurement is 5 seconds, an average elapsed time of 3.4 [second/times] is obtained by the following equation: (3 [seconds]+4 [seconds]+2 [seconds]+3 [seconds]+5 [seconds])/5 [times]=3.4 [seconds/times].

FIG. 14 shows examples of shifting speeds of individual combinations of “preceding commands” and “input commands”. In FIG. 14, “the required number of times buttons are pressed” corresponds to the requisite minimum number of times the operation unit 10 is operated. Specifically, for example, the number of times buttons are pressed in the operation unit 10 by the time the command “hue” serving as the “input command” is input after a state in which the command “color density” serving as the “preceding command” has been selected is 3, and the number of times the buttons are pressed in the operation unit 10 by the time the command “sharpness” serving as the “input command” is input after a state in which the command “color density” serving as the “preceding command” has been selected is 4. Note that when a command is input by pressing the command display/input unit 17, the number of times an operation is performed is 1.

The “shifting speed” is calculated by dividing “the required number of times buttons are pressed” by the “average elapsed time”. This value serves as an index of the number of times in which buttons are pressed per one second. In the examples shown in FIG. 14, for example, a shifting speed required for shifting from the command “hue” to the command “color density” is obtained by the following equation: 3/5=0.6. Similarly, a shifting speed required for shifting from the command “hue” to the command “detailed control” is obtained by the following equation: 5/10=0.5.

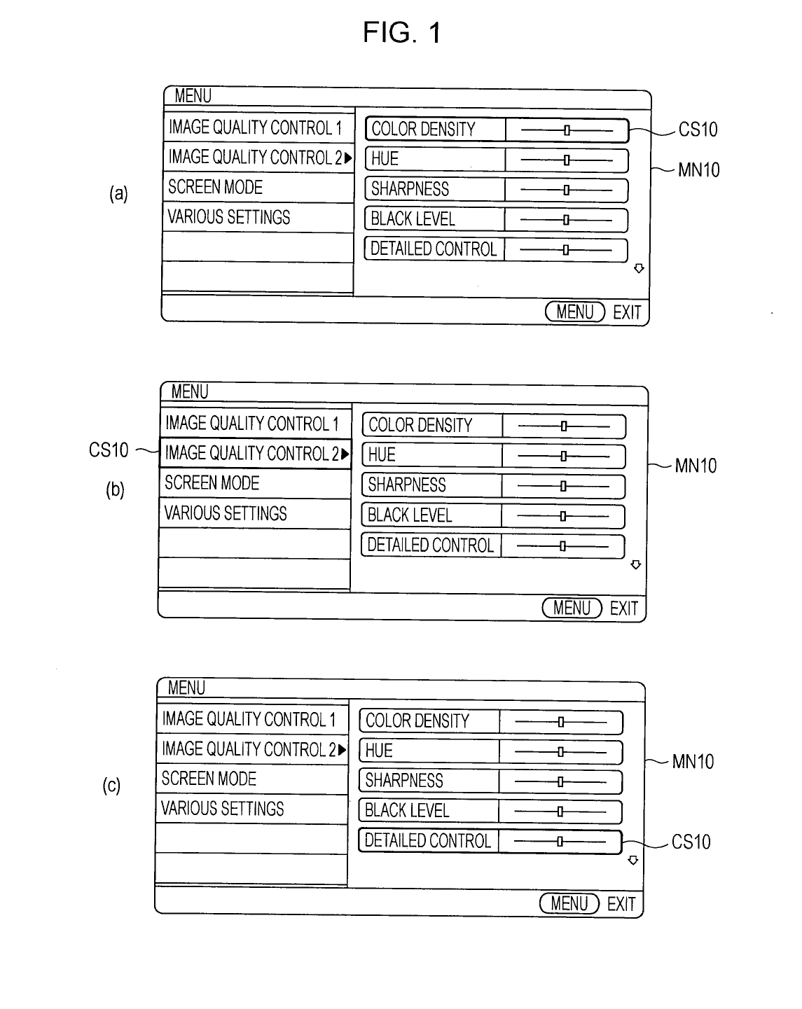

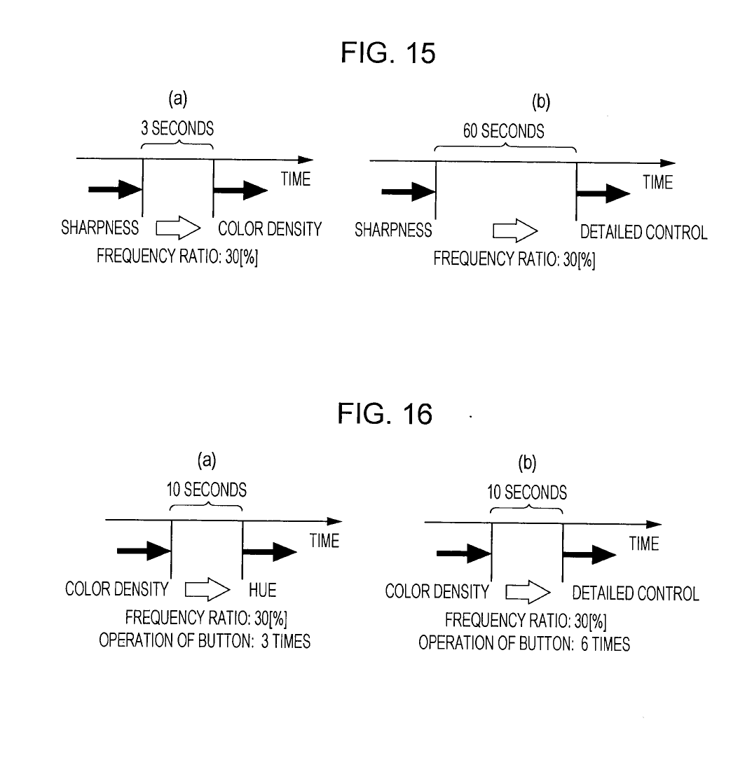

Next, a reason the index described above is used for a calculation of a degree of an association between commands will be described with reference to FIGS. 15(a) and 15(b) and FIGS. 16(a) and 16(b). FIGS. 15(a) and 15(b) are diagrams illustrating associations between a command selection time and a command association degree, and FIGS. 16(a) and 16(b) are diagrams illustrating associations between the number of times operations are performed when a command is changed to another command and a command association degree. FIGS. 15(a) and 15 (b) and FIGS. 16(a) and 16 (b) show examples of a case where a preceding command is followed by a next command in the menu layer shown in FIG. 1 which is described as a conventional example. FIG. 15(a) shows an example of a state in which the command “color density” is selected after the command “sharpness” is selected. FIG. 15(b) shows an example of a state in which the command “detailed control” is selected after the command “sharpness” is selected. Furthermore, a frequency ratio obtained when the command “color density” is selected after the command “sharpness” is selected and a frequency ratio obtained when the command “detailed control” is selected after the command “sharpness” is selected are the same as each other, that is, 30%.

Furthermore, FIG. 15(a) represents that three seconds has been elapsed by the time the command “color density” is selected after a state in which the command “sharpness” has been selected. FIG. 15(b) represents that 60 seconds has been elapsed by the time the command “detailed control” is selected after a state in which the command “sharpness” has been selected.

When only the numbers of selections are used for obtaining frequencies, a result “30%” is obtained in both of the cases shown in FIGS. 15(a) and 15(b). However, in the menu structure shown in FIG. 1, although a difference between a procedure of selecting the command “color density” after the state in which the command “sharpness” has been selected and a procedure of selecting the command “detailed control” after the state in which the command “sharpness” has been selected is negligible, the selection times thereof are considerably different from each other. This may occur due to user's conscious mind. That is, the user has a tendency to control “color density” after control of “sharpness”. Therefore, it is considered that, as a preference of this user, a degree of an association between the command “sharpness” and the command “color density” is high.

FIGS. 16(a) and 16(b) are diagrams illustrating an association between the number of times operations are performed when commands are changed from one to another and a command association degree. FIG. 16(a) shows an example of a state in which the command “hue” is selected after a state in which the command “color density” has been selected. FIG. 16(b) shows an example of a state in which the command “detailed control” is selected after a state in which the command “color density” has been selected. Furthermore, a frequency ratio obtained when the command “hue” is selected after the state in which the command “color density” has been selected and a frequency ratio obtained when the command “detailed control” is selected after the state in which the command “color density” has been selected are the same as each other, that is, 30%.

Furthermore, FIG. 16(a) represents that the number of operations (the number of button-pressing operations) required by the time the command “hue” is selected after the state in which the command “color density” has been selected is 3. FIG. 16(b) represents that the number of operations required by the time the command “detailed control” is selected after the state in which the command “color density” has been selected is 6. Then, in both of the cases of FIGS. 16(a) and 16(b), a period of time required for changing commands from one to another is the same, that is, 10 seconds.

Normally, a case where the number of required operations is 6 should require more time when compared with a case where the number of required operation is 3. However, in both of the cases, 10 seconds are required for changing commands from one to another. That is, the user has a tendency to select the command “detailed control” after selecting the command “color density”, and therefore, the operation time may be short. That is, it is considered that, as a preference of this user, an association between the command “color density” and the command “detailed control” is high.

When taking the number of actual pressings into consideration as the number of operations without taking the number of operations and the elapsed time into consideration, the number of operations and the elapsed time obtained while the user is hesitating over a selection of a command may be used for a calculation of a command association degree. This operation is not exactly performed by taking a user's preference into consideration. Therefore, in this embodiment, the calculation of a command association degree is performed on the basis of not only the number of pressings actually performed when commands are changed from one to another but also the requisite minimum number of operations and the average elapsed time required for shifting of commands from one to another.

As described above, since the degree of an association between commands is calculated taking not only the number of times the “input command” is input after the “preceding command” but also the requisite minimum number of operations required for shifting commands from one to another, the period of time required for the shifting, and the user interface into consideration in this embodiment, a value more suitable for a type of usage of the user may be set to the degree of an association between commands.

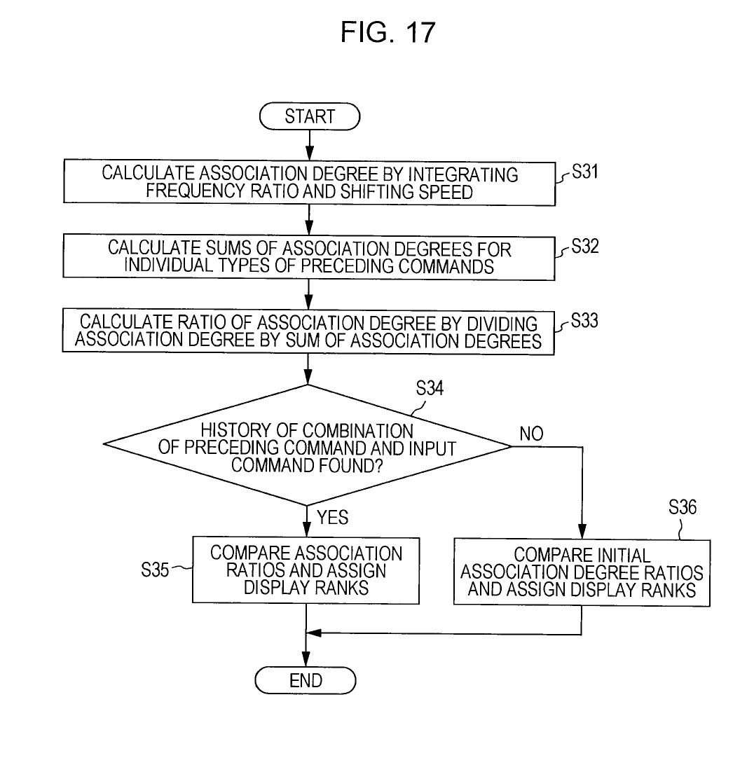

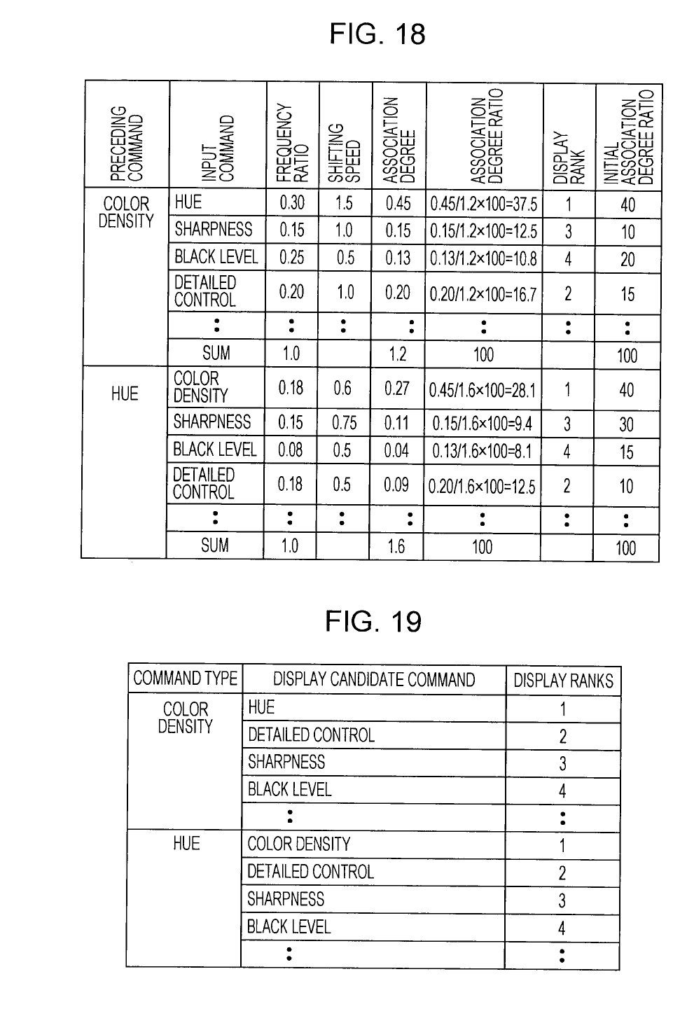

Next, an example of a process performed by the command-association-degree calculating unit 205 will be described with reference to a flowchart shown in FIG. 17 and a table shown in FIG. 18. In FIG. 17, first, the command-association-degree calculating unit 205 multiplies an input frequency calculated by the input-frequency calculating unit 203 by a shifting speed calculated by the shifting-speed calculating unit 204 so as to obtain a degree of an association between commands (in step S31). Then, sums of values obtained as association degrees are calculated for individual types of “preceding command” (in step S32), and values of the association degrees of combinations of “preceding commands” and “input commands” are divided by the corresponding calculated sums and resultant values are multiplied by 100 so that association degree ratios are obtained (in step S33).

Next, it is determined whether a history of combinations of “preceding commands” and “input commands” has been stored (in step S34). When it is determined that the history has been stored, a process of assigning display ranks is performed in accordance with the association degree ratios obtained in step S33 (in step S35). When it is determined that the history has not been stored, a process of assigning display ranks in order of association degree ratio is performed with reference to preset “initial association degree ratios” (in step S36).

FIG. 17 shows examples of association degree ratios and display ranks of combinations of “preceding commands” and “input commands”. In FIG. 17, “frequency ratio” represents a frequency ratio calculated by the input-frequency calculating unit 203, and “shifting speed” represents a shifting speed calculated by the shifting-speed calculating unit 204. The “association degree” calculated in step S31 of FIG. 17 is obtained by multiplying “frequency ratio” by “shifting speed”. For example, in a case where the “preceding command” corresponds to the command “color density” and the “input command” corresponds to the command “hue”, an association degree of 0.45 is obtained by the following equation: 0.30*1.5=0.45. Furthermore, in a case where the “preceding command” corresponds to the command “color density” and the “input command” corresponds to the command “black level”, an association degree of 0.13 is obtained by the following equation: 0.25*0.5=0.13.

As is described in step S33 of FIG. 17, an “association degree ratio” is obtained by dividing a value of an association degree by a sum of values of association degrees. As shown in FIG. 18, for example, the command “color density” serving as the “preceding command” corresponds to the commands “hue”, “sharpness”, “black level”, “detailed control”, and the like serving as the “input commands”, and a sum of association degrees of these commands is 1.2. Therefore, in a case where the “preceding command” corresponds to the command “color density” and the “input command” corresponds to the command “hue”, since an association degree is 0.45 and the sum is 1.2, an association degree ratio of 37.5(%) is obtained by the following equation: 0.45/1.2*100=37.5(%). Furthermore, in a case where the “preceding command” corresponds to the command “color density” and the “input command” corresponds to the command “black level”, since an association degree is 0.13, an association degree ratio of 10.8(%) is obtained by the following equation: 0.13/1.2*100=10.8(%).

Among the “input commands” corresponding to the command “color density”, the command “hue” has the highest association degree ratio of 37.5, followed by the command “detailed control” having an association degree ratio of 16.7, the command “sharpness” having an association degree ratio of 12.5, and the command “black level” having an association ratio of 10.8. Then, the command-association-degree calculating unit 205 assigns display ranks in this order. That is, the highest display rank is assigned to the command “hue”, the second highest display rank is assigned to the command “detailed control”, the third highest display rank is assigned to the command “sharpness”, and the fourth highest display rank is assigned to the command “black level”. The ranks obtained as described above are stored in the memory 18, for example, in a state in which the ranks are associated with the corresponding “preceding commands” and the corresponding “input commands” as shown in FIG. 18.

Note that in a case where the command “color density” corresponds to the “preceding command” and a command “noise reduction” corresponds to the “input command”, for example, and a history of this combination has not been stored, a display rank is set with reference to an “initial association degree ratio” set for the combination of the commands “color density” and “noise reduction”. For example, if this combination has “initial association degree ratio” of 12, the fourth display rank is assigned since an association degree ratio between the commands “color density” and “black level” of 10.8 is smaller than 12 and an association degree ratio between the commands “color density” and “sharpness” of 12.5 is larger than 12.

Furthermore, although a method for multiplying the “frequency ratio” by the “shifting speed” is taken as an example as a method for calculating the “association degree”, the “association degree” may be obtained by a weighted sum of the “frequency ratio” and the “shifting speed”.

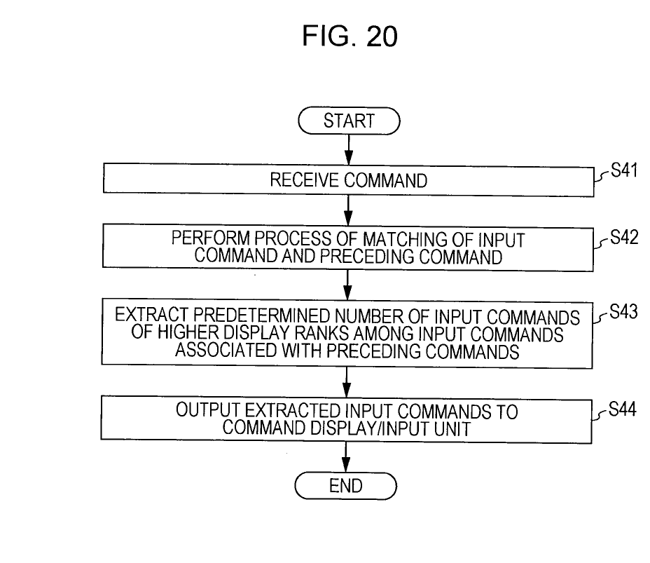

Next, an example of a process performed by the display-command extracting unit 208 will be described with reference to a table shown in FIG. 19 and a flowchart shown in FIG. 20. In FIG. 20, the display-command extracting unit 208 receives a command output from the operation unit 10 (in step S41), and performs a process of matching the received command with a “preceding command” (in step S42). Specifically, a “preceding command” of a type the same as that of the received command is selected. Then, among “input commands” associated with the “preceding command”, a predetermined number of “input commands” having higher display ranks are extracted (in step S43), and the extracted “input commands” are output to the command display/input unit 17 (in step S44).

For example, in a case where the command “color density” is received in step S41, a process of matching the received command “color density” with a command “color density” serving as a “preceding command” is performed (in step S42). Then, among the commands “hue”, “detailed control”, “sharpness”, and “black level” serving as the “input commands” associated with the command “color density”, a predetermined number of “input commands” are extracted in order of display rank (in step S43). Note that, the predetermined number of commands corresponds to the number of command display input buttons included in the command display/input unit 17. In this embodiment, since three command display input buttons 17a to 17c are provided as the command display input buttons, the predetermined number of commands corresponds to 3.

By performing this process, the table shown in FIG. 19 is generated. In FIG. 19, an item “command type” corresponds to the item “preceding command” shown in FIG. 18, and an item “display candidate command” corresponds to the item “input command” shown in FIG. 18. In FIG. 19, among “display candidate commands” associated with the command “color density”, the command “hue” has the highest display rank, the command “detailed control” has the second highest display rank, and the command “sharpness” has the third highest display rank. Therefore, these three “display candidate commands” are output to the command display/input unit 17 (in step S44).

Note that, when generating a list of display ranks as shown in FIG. 19, the display-command extracting unit 208 may refer to not only data stored in the first display-ranking storage unit 206 but also data stored in the second display-ranking storage unit 207. As a setting, both of the data may be simultaneously referred to, or only one of the data may be referred to. The user determines a setting to be employed.

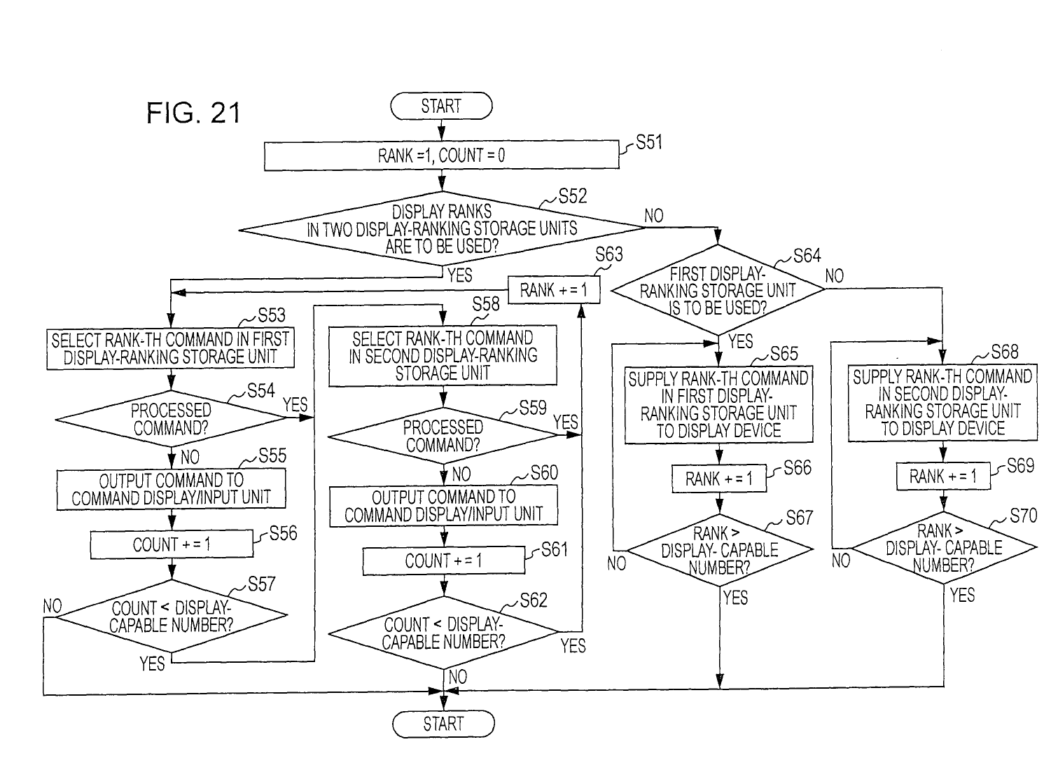

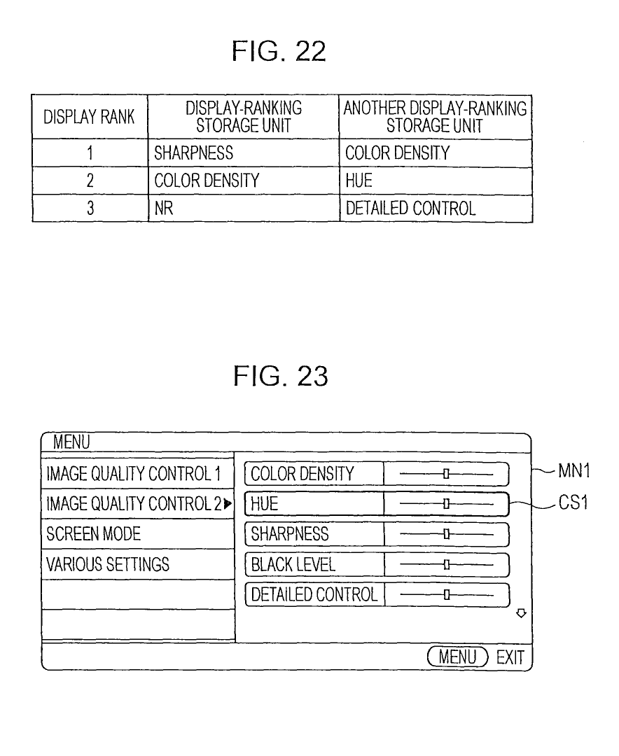

An example of a process performed by the display-command extracting unit 208 in this case will be described with reference to a flowchart shown in FIG. 21 and FIG. 22. In FIG. 21, first, the display-command extracting unit 208 assigns 1 to a variable RANK and 0 to a variable COUNT (in step S51). The numeric value assigned to the variable RANK corresponds to “display rank” in the display rank list shown in FIG. 18. When the variable RANK is 1, the “input command” corresponding to the highest display rank in the list is to be processed. For example, in FIG. 18, the command “hue” is to be processed.

The value assigned to the variable COUNT corresponds to the number of commands to be displayed in the command display/input unit 17 (=the number of command display input buttons). In this embodiment, since the number of commands to be displayed in the command display/input unit 17 is 3, the process performed by the display-command extracting unit 208 is terminated when the variable COUNT becomes larger than 3.

Next, in step S52, it is determined whether both of the display rank information stored in the two display rank storage units are used. The two display rank storage units corresponds to the first display-ranking storage unit 206 and the second display-ranking storage unit 207. In a case where the user determines that both of the display rank information stored in the two display rank storage units are to be used, “YES” is selected, and the process proceeds to step S53.

In step S53, the RANK-th command of the first display-ranking storage unit 26, that is, an “input command” having the highest display rank in the list stored in the first display-ranking storage unit 206 is determined to be a command of interest. Here, it is assumed that a list shown in FIG. 22 corresponds to the display rank lists stored in the first display-ranking storage unit 206 and the second display-ranking storage unit 207. FIG. 22 shows a list including display ranks and “input commands” extracted from the display rank lists stored in the first display-ranking storage unit 206 and the second display-ranking storage unit 207.

In FIG. 22, the commands “sharpness”, “color density”, and “NR (noise reduction)” correspond to “input commands” having the first to third highest display ranks, respectively, stored in the first display-ranking storage unit 206. The commands “color density”, “hue”, and “detailed correction” correspond to “input commands” having the first to third highest display ranks, respectively, stored in the second display-ranking storage unit 207.

Therefore, the command of interest determined in step S53 corresponds to the command “sharpness” having the highest display rank stored in the first display-ranking storage unit 206. Then, it is determined whether the command of interest, i.e., the command “sharpness” is an already-processed command (in step S54). The already-processed command means a command which has been processed in operations in the flowchart before this step has been reached. Since the command “sharpness” has processed for the first time among the processes of the flowchart of FIG. 21, “NO” is selected here, and the process proceeds to step S55.

Then, in step S55, a process of outputting the command of interest determined in step S53 to the command display/input unit 17 is performed. That is, the command “sharpness” is output to the command display/input unit 17. After this process, 1 is added to the variable COUNT (in step S56), and it is determined whether a value included in the variable COUNT is equal to or smaller than the number of commands to be displayed (in step S57). The value included in the variable COUNT is 1 since 1 has been added to an initial value of 0 in step S56, and “the number of commands to be displayed” corresponds to the number of command to be displayed in the command display/input unit 17, and is 3 in this embodiment. Therefore, since an inequality COUNT (1)≦the number of commands to be displayed (3) is satisfied, “YES” is selected and the process proceeds to step S58.

In step S58, the RANK-th command in the second display-ranking storage unit 207 is determined to be a command of interest. In this step, the value assigned to the variable RANK is still 1, and therefore, an “input command” having the highest display rank in the second display-ranking storage unit 207 corresponds to the command of interest. In the example shown in FIG. 22, the command “color density” corresponds to the command of interest. Next, it is determined whether the command of interest is an already-processed command (in step S59). Since the command “color density” is also to be processed for the first time in this step, “NO” is selected.

Then, subsequently, in step S60, a process of outputting the command of interest determined in step S58 to the command display/input unit 17 is performed. Since the command of interest determined in step S58 corresponds to the command “color density”, the command “color density” is output to the command display/input unit 17.

Here, 1 is further added to the variable COUNT (in step S61), and it is determined whether the value included in the variable COUNT is equal to or smaller than the number of commands to be displayed (in step S62). The value included in the variable COUNT is 2 since 1 is added in step S61 to 1 obtained in step S57, and “the number of commands to be displayed” is 3. Therefore, an inequality COUNT (2)≦the number of commands to be displayed (3) is not satisfied, and accordingly, “NO” is selected and the process proceeds to step S63.

In step S63, 1 is added to the variable RANK. In this step, the value included in the variable RANK is 2. Then, the process returns to step S53, and the RANK-th command of the first display-ranking storage unit 206 is determined to be a command of interest. Since an “input command” having the second highest display rank in the first display-ranking storage unit 206 corresponds to the command “color density” in the example shown in FIG. 22, the command “color density” corresponds to the command of interest.

Subsequently, in step S54, it is determined whether the command is an already-processed command. Since the command “color density” has already processed, “YES” is selected and the process proceeds to step S58. Then, the RANK-th command in the second display-ranking storage unit 207 is determined to be a command of interest. In this step, since the value included in the variable RANK is 2, the command of interest here is the command “hue” which is an “input command” having the second highest display rank in the second display-ranking storage unit 207.

Next, in step S59, it is determined whether the command is an already-processed command. Since the command “hue” is to be processed for the first time in this step, “NO” is selected and the process proceeds to step S60. Then, in step S60, a process of outputting the command of interest determined in step S58 to the command display/input unit 17 is performed.

Subsequently, 1 is added to the variable COUNT in step S61, and therefore, the variable COUNT is 3. Therefore, an inequality COUNT (3)≦the number of commands to be displayed (3) is satisfied in step S62. Accordingly, “YES” is selected, and the process is terminated.

In a case where the user determined to refer to only display ranking included in a single display-ranking storage unit, “NO” is selected in step S52, and the process proceeds to step S64. When the user determined that only display ranking included in the first display-ranking storage unit 206 is to be referred to, “YES” is selected, and subsequently, in step S65, the RANK-th command of the first display-ranking storage unit 206 is determined to be a command of interest. Here, since the variable RANK is still the initial value of 1, the command “sharpness” having the highest display rank in the first display-ranking storage unit 206 corresponds to the command of interest.

Next, a process of adding 1 to the value assigned to the variable RANK is performed (in step S66), and it is determined whether the value assigned to the variable RANK is larger than the number of commands to be displayed (in step S67). Since the value assigned to the variable RANK is 2 in step S66 and the number of commands to be displayed is 3, the determination is negative. Therefore, the process returns to step S65.

In step S65, the RANK-th command of the first display-ranking storage unit 206 is determined to be a command of interest. Here, the variable RANK is 2, and therefore, the command “color density” having the second highest display rank in the first display-ranking storage unit 206 corresponds to the command of interest. Next, the process of adding 1 to the value assigned to the variable RANK is performed (in step S66), and it is determined whether the value assigned to the variable RANK is larger than the number of commands to be displayed (in step S67). Since the value assigned to the variable RANK is 3 in step S66 and the number of commands to be displayed is 3, the determination is negative, and accordingly, the process returns to step S65 again.

In step S65, the RANK-th command of the first display-ranking storage unit 206 is determined to be a command of interest. Here, since the variable RANK is 3, the command “NR” having the third highest display rank in the first display-ranking storage unit 206 corresponds to the command of interest. Next, the process of adding 1 to the value assigned to the variable RANK is performed (in step S66), and it is determined whether the value assigned to the variable RANK is larger than the number of commands to be displayed (in step S67). Since the value assigned to the variable RANK is 4 in step S66 and the number of commands to be displayed is 3, the determination is affirmative. Therefore, the process is terminated.

In a case where the user determined to refer to only display ranking of the second display-ranking storage unit 207, “NO” is selected in step S64 and the process proceeds to step S68. Operations performed in step S68 to step S70 are the same as those performed in step S65 to step S67, and therefore, descriptions thereof are omitted. In a case where the display-command extracting unit 208 refers to the display ranks shown in FIG. 22, the commands “color density”, “hue”, and “detailed correction” are output to the command display/input unit 17 by performing the operations in step S68 to step S70.

The command display/input unit 17 performs a process of assigning the three commands transmitted from the display-command extracting unit 208 to the command display input buttons 17a to 17c in order of display rank and displaying the commands. For example, when the commands “hue”, “detailed control”, and “sharpness” are transmitted from the display-command extracting unit 208, the command “hue” is displayed in the command display/input button 17a, the command “detailed control” is displayed in the command display/input button 17b, and the command “sharpness” is displayed in the command display/input button 17c, similarly to the case of FIG. 5.

The command display input buttons 17a to 17c serve as operation units as well as display units. When receiving a pressing operation performed by the user, each of the command display input buttons 17a to 17c generates an actual command corresponding to a displayed command to be output. In a case where the user pressed the command display/input button 17a represented by the command “hue”, a signal for instructing output of a control screen for the command “hue” is transmitted to the reproducing device 100. Then, in the display unit 105 of the reproducing device 100, the menu screen MN1 is displayed as shown in FIG. 23, and in the menu screen MN1, the cursor CS1 points the command “hue” included in the item “image quality control 2”. That is, the command “hue” is selected and a state in which the control of “hue” is available is entered.

Note that, in the foregoing process, since the calculation of a degree of an association between commands is performed every time the command storage determination unit 202 performs an output process, commands displayed in the command display/input unit 17 are changed where appropriate. However, a setting in which display ranks of commands to be displayed in the command display/input unit 17 are not updated may be performed. In a case where the user selects the setting in which command association degree information is not updated through the operation unit 10 or the like, output of commands is not performed by the command storage determination unit 202.

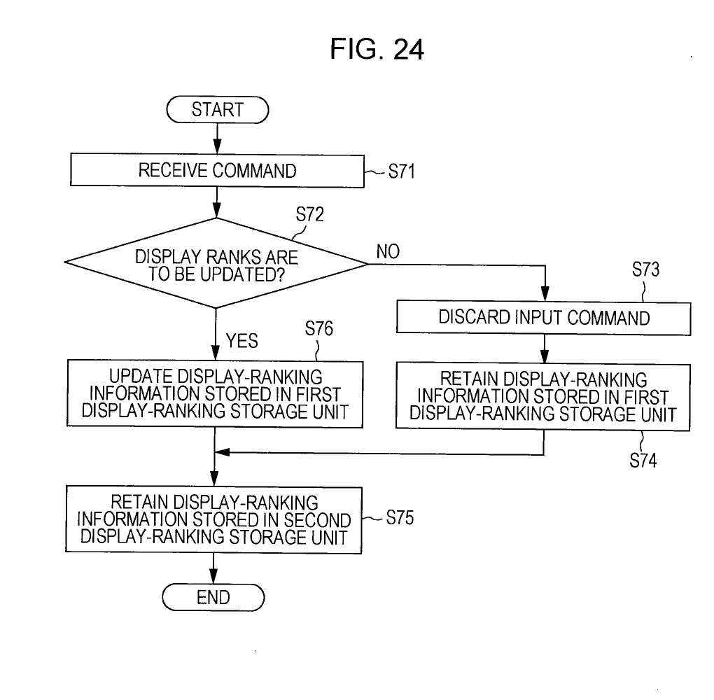

FIG. 24 shows an example of a process performed by the command storage determination unit 202. First, when receiving an input of a command (in step S71), the command storage determination unit 202 determines whether the user performed a setting in which command display ranking is to be updated (in step S72). When a setting in which the command display ranking is not to be updated has been performed, the process proceeds to step S73 where the input command received in step S71 is discarded. By this, the display ranking information stored in the first display-ranking storage unit 206 is retained (in step S74), and the display ranking stored in the second display-ranking storage unit 207 is also retained (in step S75).

When the user performed the setting in which the display ranking is to be updated, “YES” is selected in step S72 and the display ranking stored in the first display-ranking storage unit 206 is updated (in step S76). Specifically, the command storage determination unit 202 outputs a command and a degree of an association between commands is calculated in accordance with the command, and therefore, the command display ranking stored in the first display-ranking storage unit 206 is also updated. However, also in this case, as described in step S75, the display ranking stored in the second display-ranking storage unit 207 is not updated.

Next, an example of a process of supplying the operation history information stored in the operation history storage unit 201 and the display ranking information (refer to FIG. 14) stored in the display-command extracting unit 208 to the server 300 will be described. The information is supplied to the server 300 in a predetermined cycle, such as every two months, or when predetermined amounts of data are stored in the regions. Note that, since the information is private information of the user, user's consent should be gained before the data is supplied to the server 300.

In this embodiment, before the information is supplied to the server 300, the information is first stored in the external storage medium 18, and the external storage medium 18 is attached to the reproducing device 100, so that the information is transmitted from the reproducing device 100 to the server 300 through the network 50. Therefore, a message prompting the user to perform confirmation or the like is displayed in the display unit 15 of the remote control device 200 or the display unit 105 of the reproducing device 100, for example, when the data is output to the external storage medium 18 or the data is transmitted from the reproducing device 100 to the server 300. Note that, as described above, a method for transmitting the information stored in the remote control device 200 to the server 300 is not limited to the method described above. Therefore, even when another method is employed, the confirmation should be performed before the data is transmitted to the server 300.

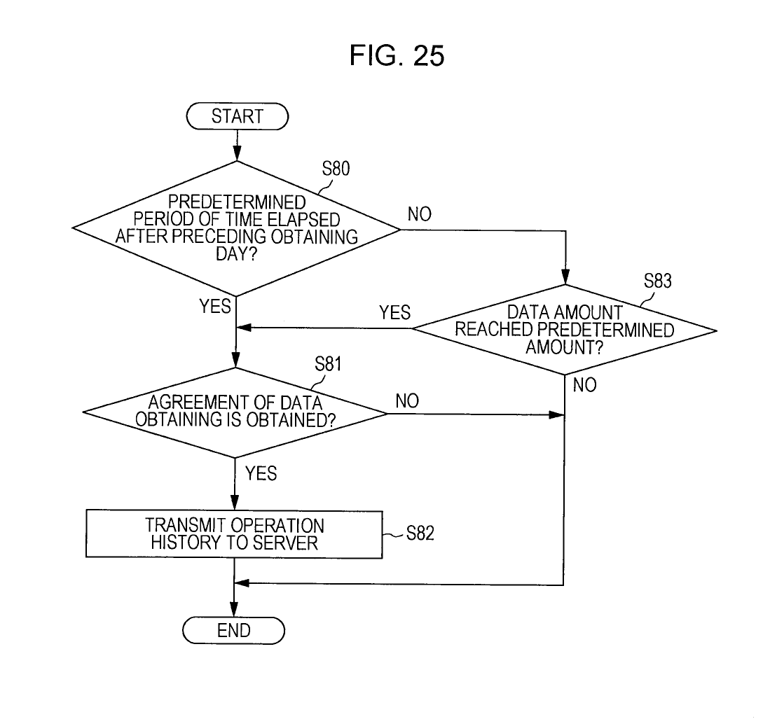

FIG. 25 shows a flowchart of a process performed when the information is supplied to the server 300 (when the data is obtained). First, it is determined whether a predetermined period of time has been elapsed in accordance with a day when data was obtained last time (in step S80). When two months is set as a data obtaining period, it is determined whether two months has been elapsed from when data was obtained last time.

When it is determined that the predetermined period of time has been elapsed from when data was obtained last time, the process proceeds to step S81 where it is determined whether a user's agreement on the data obtaining has been obtained (in step S81). When the agreement on the data obtaining has been obtained, the process of supplying data to the server 300 is performed (in step S82). When the agreement on the data obtaining has not been obtained, the process is terminated.

When it is determined that the predetermined period of time has not been elapsed after the day when data was obtained last time, “NO” is selected in step S80 and the process proceeds to step S83. Then, it is determined whether an amount of data reached a predetermined amount. When it is determined that the amount of data reached the predetermined amount, the process proceeds to step S81 whereas when it is determined that the amount of data does not reach the predetermined amount, the process is terminated. This checking operation is performed once a day when the reproducing device 100 is first activated. Note that information on a user name is included in the information to be supplied to the server 300 so that the server 300 recognizes the user serving as a data transmission source.

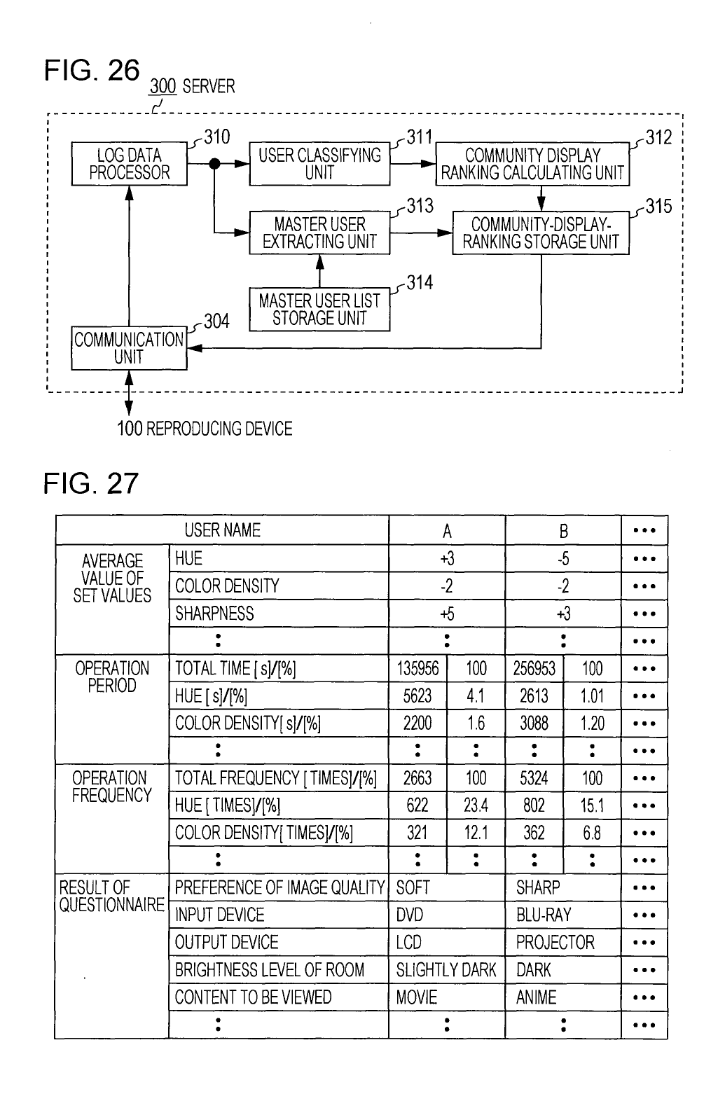

Next, an example of an internal configuration of the server 300 and examples of processes performed by various units will be described. FIG. 26 is a function block diagram illustrating the server 300. The server 300 includes the communication unit 304, a log data processor 310, a user classifying unit 311, a community-display-ranking calculating unit 312, a master-user extracting unit 313, a master-user-list storage unit 314, and a community-display-ranking storage unit 315.

The communication unit 304 has been described with reference to FIG. 4, and therefore, a description thereof is omitted. The log data processor 310 processes user operation history information received through the communication unit 304 so that data usable as a criterion for classification of the user into a certain community is obtained. The operation history information supplied from the user includes, as shown in FIG. 8, information on types of command selected by the user, information on dates and times when command selections are started and dates and times when the command selections are terminated, and information on values set in various stages in command operations.

First, the log data processor 310 calculates average values of the set values for individual command types in accordance with the information. Each of the average values of the set values for individual command types is obtained by extracting only values finally set in command operations, adding the set values to one another, and dividing an obtained sum of the set values by the number of settings. The values finally set in command operations correspond to values set at a timing when “a command “hue” is terminated” or at a timing when “a command “color density” is terminated”.

The log data processor 310 further calculates operation periods of the commands and frequencies of command operations. Then, sums of the operation periods and sums of the operation frequencies are obtained for individual commands so that operation amounts for individual commands are calculated. Furthermore, the operation periods, the operation frequencies, and the operation amounts obtained as described above are individually subjected to addition so that a total operation time, a total operation frequency, and a total operation amount are also obtained. Note that the operation frequencies obtained here are not calculated on the basis of the number of times commands are selected, but calculated on the basis of the number of times the set values are changed based on the commands. Note that since it is assumed that data storage periods are different from one another depending on users, the log data processor 310 also performs a process of normalizing various data so that the various data correspond to values in storage periods of one week, for example.

In addition, average values of the final values set by selecting the commands are calculated. FIG. 27 shows examples of data output from the log data processor 310 to the user classifying unit 311 and the master-user extracting unit 313. As items, an average value of set values, an operation period, an operation frequency, and information on answers of a questionnaire (a result of a questionnaire) are included, and the items are used as parameters (hereinafter referred to as “classification parameters” where appropriate) used to classify users into communities. Note that although an item “operation amount” is not shown in FIG. 27, data transmitted from the log data processor 310 to the user classifying unit 311 includes information on the item “operation amount”.

In FIG. 27, the classification parameters are shown for individual users including a user A and a user B. In an item “average value of set values”, a final set value of the command “hue” of the user A is “+3”, and a final set value of the command “hue” of the user B is “−5”. In an items “operation period” and “operation frequency” (and an item “operation amount”), “total operation periods” and “total operation frequencies” calculated irrespective of the types of command are shown, and below the “total operation periods” and the “total operation frequencies”, various values are shown for individual command types.

In the item “operation period”, the total operation periods and the operation periods of the individual commands are described on the second time scale. In the item “operation frequency”, the total operation frequencies and the operation frequencies of the individual commands are described by percentage.

FIG. 27 shows the total operation period for an operation of an image quality control of the user A of 135956 seconds which includes 5623 seconds and 2200 seconds for the commands “hue” and “color density”, respectively. Items on the right side of the values represent ratios obtained when the total amounts are set to 100(%). When the classification parameter “operation period” is taken as an example, a ratio of the operation period of the command “hue” of 5623 seconds to the total operation period of 135956 seconds is 4.1%. Therefore, a value 4.1 is described. The log data processor 310 transmits such data to the user classifying unit 311 and the master-user extracting unit 313.

The user classifying unit 311 performs a process of classifying users serving as data transmission sources into certain communities in accordance with the data transmitted from the log data processor 310. The classification is performed on the basis of the data calculated by the log data processor 310 and the questionnaire answer information transmitted from the users. Using the questionnaire answer information, general objects of interest and preferences of the users are defined. Furthermore, with reference to the “operation amounts” of the individual commands transmitted from the log data processor 310, functions in which the users prefer are specified, and degrees of the preferences are also measured in accordance with the operation amounts.

Furthermore, in accordance with the operation amounts, interest and a preference of a user to this system itself may be measured. The interest and the preference to this system itself means interest and a preference to operations of the remote control device 200 and interest and a preference to changing of various set values performed by the operations. For example, if a user enjoys changing image qualities which occur due to operations of the remote control device 200 and operates the remote control device 200 several times, it is determined that the user has a high degree of interest and a preference to this system itself.

The user classifying unit 311 focuses, among the data calculated by the log data processor 310, a command having the highest ratio of an operation amount and uses a type of the command and an operation amount of the command as criteria for the classification.

Note that the reason the command having the highest ratio of an operation amount is focused is that it is considered that the user is especially interested in the command having the highest ratio of an operation amount. That is, it is considered that the user's preference is reflected in a type of the command having the highest ratio of an operation amount. Furthermore, the operation amount may show the degree of the user's preference to (a function realized by) the command.

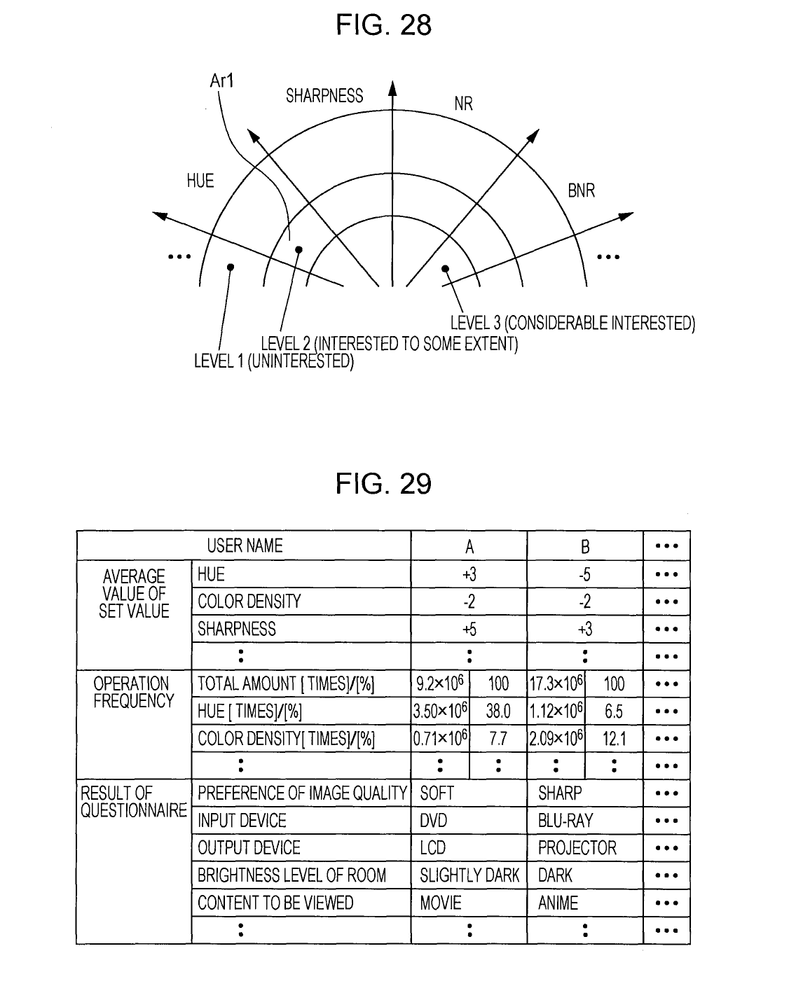

FIG. 28 shows a table in which values of operation amounts are classified into first to third levels for individual command. For example, the values of the operation amounts are classified in advance such that values of operation amounts in a range from 0 to 20% correspond to the first level, values of operation amounts in a range from 21 to 80% correspond to the second level, and values of operation amounts in a range from 81 to 100% correspond to the third level, and information on a range to which the user belongs is used as a determination criterion for community classification. Alternatively, regions shown in FIG. 28 may serve as independent communities and users may be classified into the communities. If a user corresponds to the command “hue” having the highest ratio of the operation amount of 38.0%, the user is classified into a region Ar1 of FIG. 28 which is determined by a condition in which the command is “hue” and the level is the second level.

FIG. 29 shows a table including information of average values of set values calculated by the log data processor 310, information on operation amounts, and results of questionnaires for individual users. The user classifying unit 311 performs a process of classifying the users into communities using the elements included in the table as parameters. In FIG. 29, the command “hue” corresponds to the highest ratio of an operation amount for the user A, and the ratio of the operation amount to the total operation amount is 38%. Furthermore, according to the results of questionnaires, the user A prefers an image quality of soft, uses a DVD as an input device and a liquid crystal display as an output device, selects a dark room as a brightness level of a room, and frequently selects a category of movie as content to be viewed.

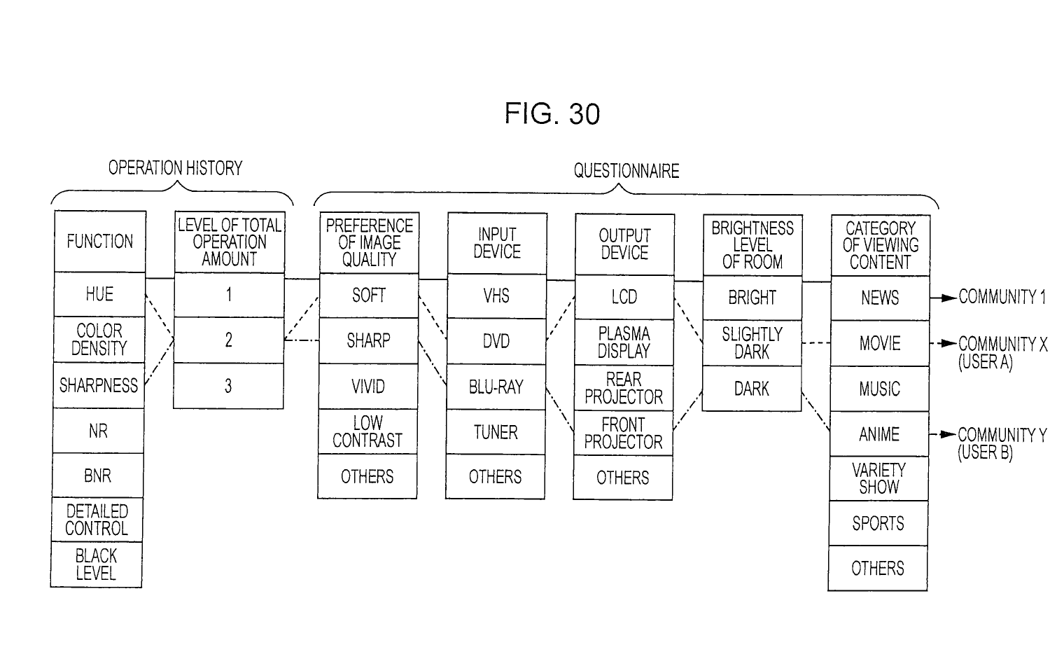

FIG. 30 shows an example of community classification performed in accordance with the information shown in FIG. 29. In FIG. 30, information on “operation histories” and information on “questionnaires” which are used as classification parameters are horizontally arranged, and detailed information of the items are arranged in a column direction. For example, in a case where the command “hue” corresponds to the highest ratio of an operation amount, the operation amount corresponds to the first level, a preference of an image quality is “soft”, an input device corresponds to a “VHS”, an output device corresponds to a “liquid crystal display”, a brightness level of a room corresponds to “bright”, and a user frequently selects “news” as a category of content to be viewed, the user is classified into a community 1 including the elements connected by a solid line.

As for the user A shown in FIG. 29 as an example, the command “hue” corresponds to the highest ratio of an operation amount, the operation amount corresponds to the second level, a preference of an image quality is “soft”, an input device corresponds to a “DVD”, an output device corresponds to a “liquid crystal display”, a brightness level of a room corresponds to “dark”, and the user A frequently selects “movie” as a category of content to be viewed, and therefore, the user A is classified into a community X. Similarly, the user B is classified into a community Y including elements connected by a dashed line.

Specifically, when the items shown in FIG. 30 are used as the community classification parameters, the number of communities is 55125 which is obtained by the following equation: 7 (the number of commands)×3 (levels of operation amounts)×5 (preferences of image qualities),×5 (input devices)×5 (output devices)×3 (brightness levels of rooms)×7 (categories of content to be viewed)=55125. Note that, although the item “average value of set values” is not used for the community classification in the example shown in FIG. 30, average values of set values may be used for the community classification.

The number of communities may be appropriately set by selecting parameters used for the community classification and by controlling threshold values of the levels. For example, communities may be configured not using the operation history information but only using the questionnaire answer information. Alternatively, the users may be classified into the communities with reference to only the operation history information. In a case where communities are configured in various methods, a single user may be included in a plurality of communities.

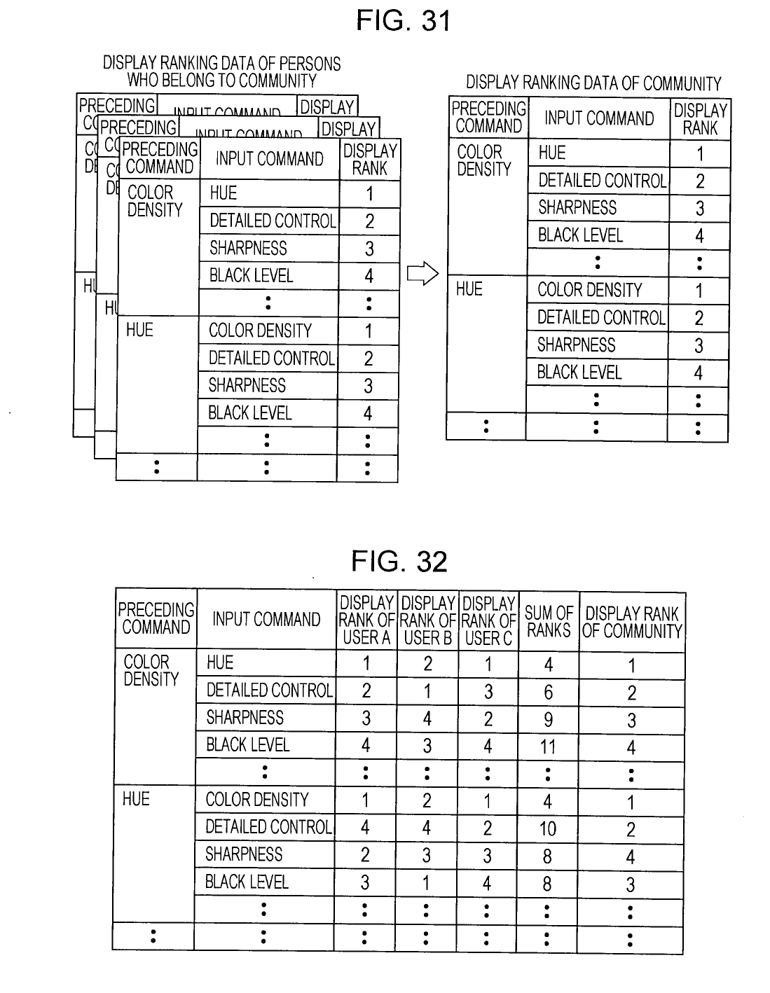

The community-display-ranking calculating unit 312 performs a process of calculating command display ranks in entire communities with reference to command display rank information of the users who belong to the communities. An image diagram of this process is shown in FIG. 31. On the left side of FIG. 31, command display ranking information of the users who belong to a certain community is shown. By adding the information, display ranking information in the community (hereinafter referred to as “community display ranking” where appropriated) is generated as shown on the right side of FIG. 31.

FIG. 32 shows an example of a community display ranking in a community to which users A, B, and C belong. The community display ranking is calculated by first adding display ranks of the users to one another for individual combinations of “preceding commands” and “input commands”. For example, in a case where the command “color density” corresponds to the “preceding command” and the command “hue” corresponds to the “input command”, a sum of display ranks is obtained by the following equation: a display rank of the user A (1)+a display rank of the user B (2)+a display rank of the user C (1)=4.

Combinations of display ranks having higher display ranks result in smaller sums of the display ranks of the users in the community. Accordingly, display ranks in the community are assigned to the combinations in ascending order of the sums of the display ranks, and the assigned display ranks are determined to be command display ranks (second display ranking information) in the community. In the example shown in FIG. 32, when the command “color density” corresponds to the “preceding command”, the command “hue” corresponds to the first rank, the command “detailed control” corresponds to the second rank, the command “sharpness” corresponds to the third rank, and the command “black level” corresponds to the fourth rank. Furthermore, the community-display-ranking calculating unit 312 calculates information on set values of the commands in the community by a method the same as that described above.

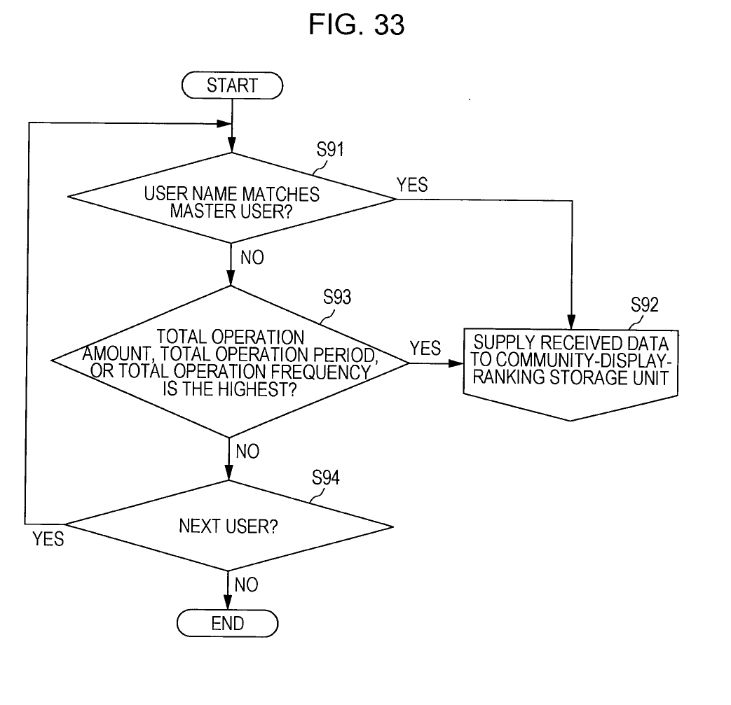

Next, an example of a process performed by the master-user extracting unit 313 will be described with reference to a flowchart of FIG. 33. A master user means, as described above, a specific user whose operations are worth being referred to by the users. Specifically, master users include famous people such as movie critics and users who operate in characteristic manners. Information on the famous people such as movie critics is stored in the master-user-list storage unit 314 in advance along with command display ranking information generated in accordance with operation histories and information on set values of individual commands. Then, when data is transmitted to a user, the display ranking information and the information on values set for individual commands which are stored in the master-user-list storage unit 314 are simultaneously read. The master-user extracting unit 313 performs a process of extracting a user having a characteristic operation history.

In FIG. 33, the master-user extracting unit 313 first determines whether a user name included in information supplied form the log data processor 310 matches one of names of master users stored in the master-user-list storage unit 314 (in step S91). When it is determined that the user name included in the received information matches one of the names of the master users, the user is determined to be a master user, and command display ranking information and information on values set for individual commands which are supplied from the log data processor 310 are output to the community-display-ranking storage unit 315 as master-user display ranking information (in step S92).

When it is determined that the user name included in the information supplied from the log data processor 310 does not match any one of the names of the master users, “NO” is selected in step S91, and the process proceeds to step S93. In step S93, it is determined whether a total operation amount, a total operation period, or a total operation frequency in the received data is the highest value in the community. When it is determined that the total operation amount, the total operation period, or the total operation frequency in the received data is the highest value in the community, the process proceeds to step S92 where a process of outputting the received data (the command display ranking information and the information on average values of values set for individual commands) to the community-display-ranking storage unit 315 is performed.

When it is determined that the total operation amount, the total operation period, or the total operation frequency in the received data is not the highest value in the community, it is determined whether the next user to be subjected to the determination exists (in step S94). When it is determined that the next user to be subjected to the determination exists, the process returns to step S91 and the process is continued. When it is determined that a user to be subjected to the determination does not exist, the process is terminated.

The command display ranking information and the information on values set for individual commands which are calculated by the community-display-ranking calculating unit 312 and the command display ranking information and the information on values set for individual commands which are extracted by the master-user extracting unit 313 are output to the community-display-ranking storage unit 315 and stored in the community-display-ranking storage unit 315. The community-display-ranking storage unit 315 stores the community display ranking information and the information on values set for individual commands which are transmitted from the community-display-ranking calculating unit 312 and the display ranking information of a master user and the information on values set for individual commands which are transmitted from the master-user extracting unit 313 after they are associated with the user.

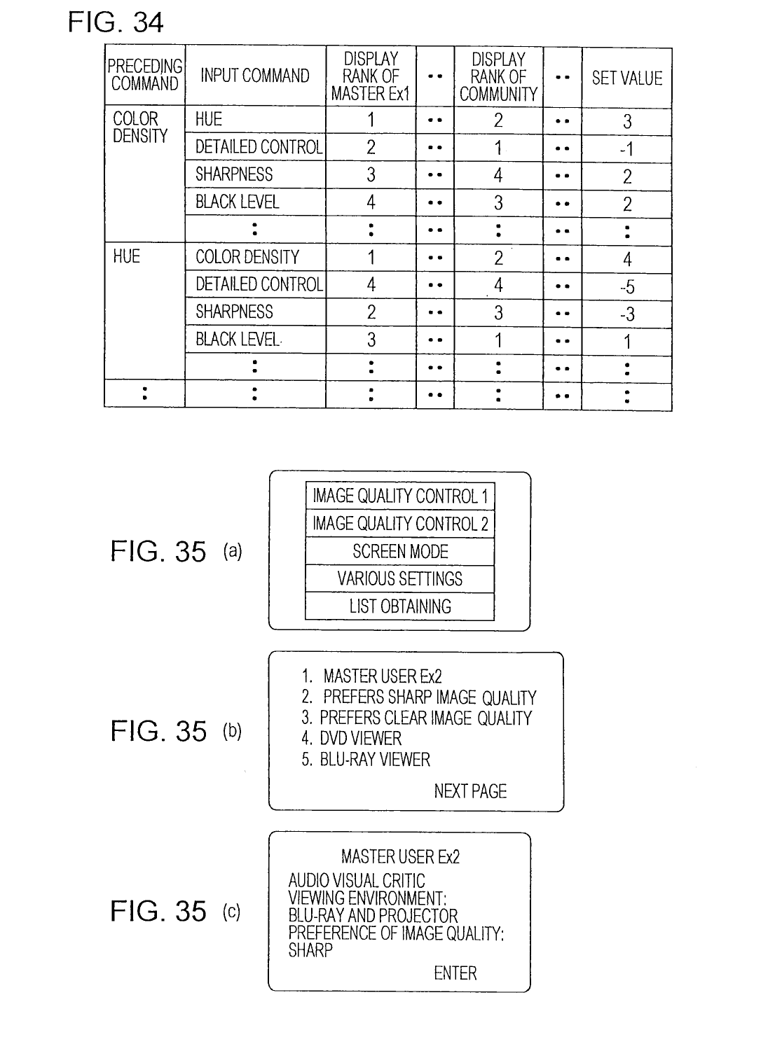

FIG. 34 shows an example of data stored in the community-display-ranking storage unit 315. Display ranks of a master user, that is, a master EX1, community display ranks, and information on set values are described for individual combinations of “preceding commands” and “input commands”. In FIG. 34, when the command “color density” corresponds to the “preceding command”, the command “hue” serving as the “input command” corresponds to the first display rank in the master EX1 and the second display rank in the community display rank and has a set value of “3”.

The display ranking information stored in the community-display-ranking storage unit 315 is transmitted to the reproducing device 100 through the communication unit 304. Then, the reproducing device 100 transmits the display ranking information and the information on values set for individual commands to the remote control device 200. In the remote control device 200, the display ranking information transmitted from the reproducing device 100 is stored in the second display-ranking storage unit 207. Then, the information is referred to in accordance with an instruction by a user when a display-ranking determination process is performed by the display-command extracting unit 208.

By performing this process, the display ranking information in the community to which the user assigned and the display ranking information of the master user are provided. In addition, this invention includes a function of allowing the user to obtain information other than the information described above.

FIGS. 35(a) to 35(c) show examples of display in the display unit 15 included in the remote control device 200. As shown in FIG. 35(a), in a state in which an option representing “list obtaining”, for example, is included in a portion of the image quality control menu, when the item “list obtaining” is selected through an input to the operation unit 10, data representing display ranks which may be obtained by the user is displayed as a list as shown in FIG. 35(b). FIG. 35(b) shows a state in which a name of a master user and community names are displayed such as “1. master user EX2”, “2. prefers sharp image”, “3. prefers clear image”, “4. DVD viewer”, and “5. Blu-ray viewer”.

Information (a list) displayed after the command “list obtaining” is pressed may be changed depending on a type of community to which the user belongs. Alternatively, names of all communities and names of all master users may be displayed as options without exception.

In the display shown in FIG. 35(b), when the user selects “1. master user EX2”, property information of the master user EX2 and the like are displayed. FIG. 35(c) shows an example of information on the master user EX2. As an introduction of the master user EX2, facts that the master user EX2 is an audio-visual critic, a view environment corresponds to a Blu-ray (disc) and a projector, and a sharp image is preferred are described. The user determines whether command display ranks generated by the selected master user are usable for the user by checking the descriptions.

When an “enter” button (or a soft key) disposed on lower right side of the screen is selected, a request for obtaining the display ranking information of the “master user EX2” is transmitted to the server 300 through the reproducing device 100. Then, the display ranking information of the master user EX2 transmitted from the server 300 is further supplied to the remote control device 200 through the reproducing device 100.

Note that, although FIGS. 35(a) to 35(c) show an example of a case where a list is displayed in the display unit 15 of the remote control device 200, the list may be displayed in the display unit 105 of the reproducing device 100.

According to the configuration and the processes of this embodiment, in the remote control device 200, when the user inputs a predetermined command through the operation unit 10 or the command display/input unit 17, commands which have the first to third highest degrees of associations with the command are displayed in the command display/input unit 17.

Furthermore, according to the configuration and the processes of this embodiment described above, the display ranking information of a community to which the user is assigned in the server 300 and the information on set values are provided for the user. By this, the user who receives display ranks may recognize information on an average operation of users having preferences and operation tendencies the same as those of the user.

Moreover, according to the configuration and the processes of this embodiment described above, the display ranking information and the information on set values generated in accordance with operation histories of users whose operation histories in the community into which the user is classified are remarkable and of famous people such as video image critic (master users) are provided. Accordingly, the user may learn a method for effectively or efficiently selecting a command which has not been thought of.

Furthermore, in this case, the provided display ranking information may be reflected to display performed by the command display/input unit, and may be used as an actual command. Moreover, since received set values may be actually used, a desired image quality may be efficiently obtained.

Furthermore, since display ranking information and information on set values which have not been transmitted to the user may be obtained by the user by using the function of “list obtaining”, the user may obtain desired display ranking information or desired information on set values. Accordingly, even when an image quality is to be controlled so that an image quality which is different than usual is obtained, the user easily obtains an operation procedure. For example, if a user who usually prefers an image quality of soft wishes to perform control of the image quality so as to obtain an image quality of sharp, display ranking information in a community “prefers sharp image quality” is obtained using the function of “list obtaining”. By this, repeated trial-and-error may be omitted when the control is performed so that the desired image quality is obtained. That is, work efficiency of the user is enhanced.

Moreover, according to the configuration of this embodiment, the display ranking information to be updated in accordance with the operation history may be stored in the second display-ranking storage unit 207. Accordingly, when the user satisfies to some extent the types of command and the display ranks displayed in the command display/input unit 17, the setting may be stored by transferring information stored in the first display-ranking storage unit 206 to the second display-ranking storage unit 207.

Note that, although the case where a desired menu (command) is selected in the menu screen having a plurality of layers is taken as an example in the foregoing embodiment, the present invention is not limited to such a case where a GUI (Graphical User Interface) is operated. A button which is assumed to be pressed after a currently pressed button may be displayed in the command display/input unit 17 by setting a shifting distance obtained by the shifting-speed calculating unit 204 as a distance between buttons in the remote control device 200.

### Second Embodiment

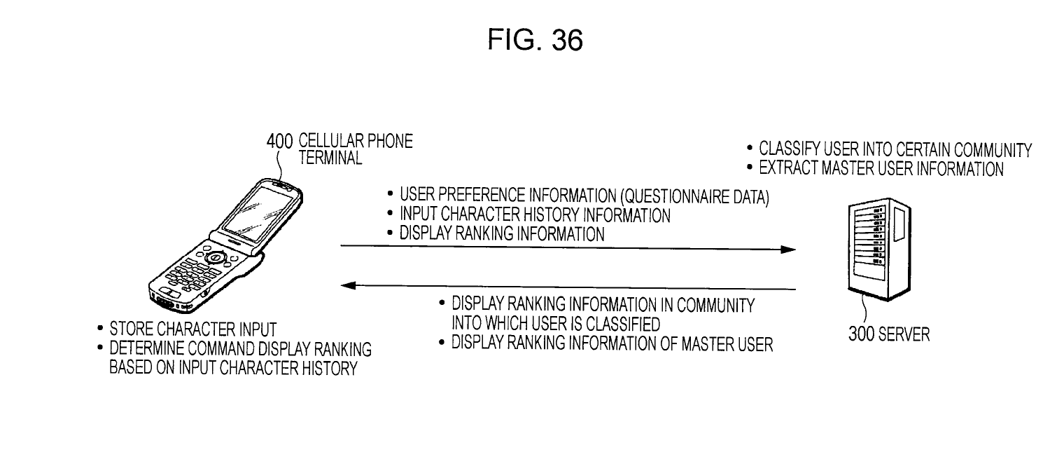

Next, a second embodiment of the present invention will be described with reference to FIGS. 36 to 47. In this embodiment, an information signal processing apparatus of the present invention is applied to a cellular phone terminal. FIG. 36 is a diagram illustrating an outline of a system of this embodiment. This system includes a cellular phone terminal 400 and a server 300. A configuration of the server 300 is the same as that of the server 300 in the first embodiment, and only types of data to be processed are different.

The cellular phone terminal 400 of this embodiment has a function of displaying characters and phrases (words) which are expected to be input after characters and phrases input by a user as display candidates in a predetermined region in a display unit. That is, the “commands” in the first embodiment correspond to words including characters and symbols. Also in this embodiment, display ranks of “input commands” corresponding to a “preceding command” are determined on the basis of information on a history of operation inputs performed by the user. Accordingly, the words including characters and symbols are also referred to as “commands” hereinafter.

The cellular phone terminal 400 accepts inputs for questionnaires at a time of an initial setting so that a user's preference is obtained. The cellular phone terminal 400 supplies the obtained questionnaire information, input-character history information which has been stored therein, and display ranking information calculated in accordance with an input-character history to the server 300. The server 300 extract information (command display ranking information) which is considered to be usable for the user of the cellular phone terminal 400 in accordance with the information supplied from the cellular phone terminal 400 and supplies the extracted information to the user.

As with the case of the first embodiment, the server 300 stores information on communities therein, and classifies a user who is an information transmission source into a certain community when the information is supplied from the cellular phone terminal 400. Then, command display ranking information of other users in the classified community and command display ranking information of a master user are supplied to the user.

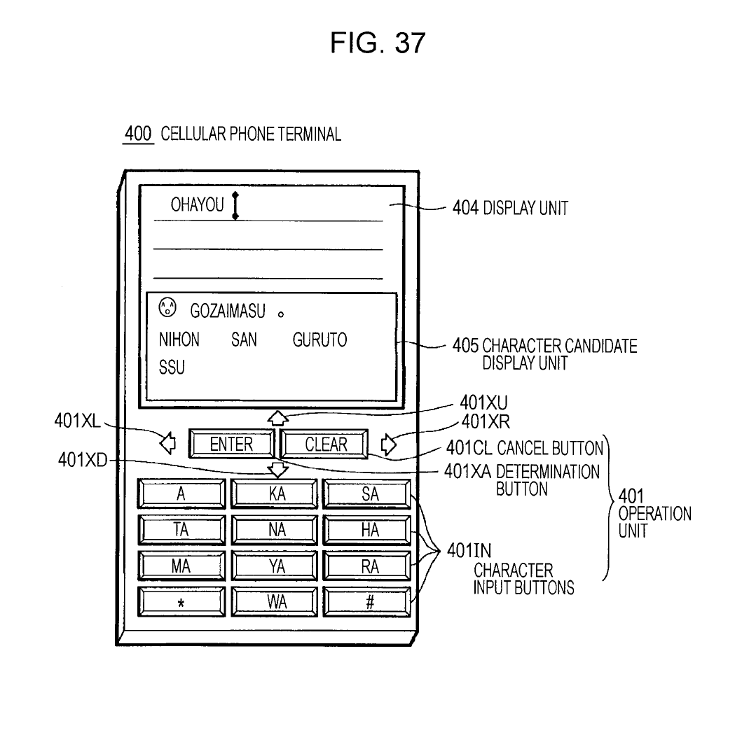

FIG. 37 shows an example of a configuration of the cellular phone terminal 400. The cellular phone terminal 400 includes a display unit 404 constituted by an LCD, for example, a character candidate display unit 405 serving as a command display/input unit which is disposed in a certain region in the display unit 404, and an operation unit 401. The operation unit 401 includes a determination button 401XA, a cancel button 401CL, an up button XU, a right button 401XR, a down button 401XD, a left button 401XL, character input buttons 401IN and the like.

The display unit 404 displays an electric mail generation screen, Web pages, characters and symbols which have been input using the character input buttons 401IN, and images stored in a memory 403, which will be described hereinafter. The display unit 404 includes the character candidate display unit 405 which displays characters and symbols, for example, which are highly associated with a character or a symbol input using the character input buttons 401IN or the like. The characters and symbols displayed in the character candidate display unit 405 may be selected by operating the up button 401XU, the right button 401XR, the down button 401XD, or the left button 401XL.

Content displayed in the display unit 404 and the character candidate display unit 405 is selected by pressing the determination button 401XA, and the content is deleted or the selection of the content is cancelled by pressing the cancel button 401CL.

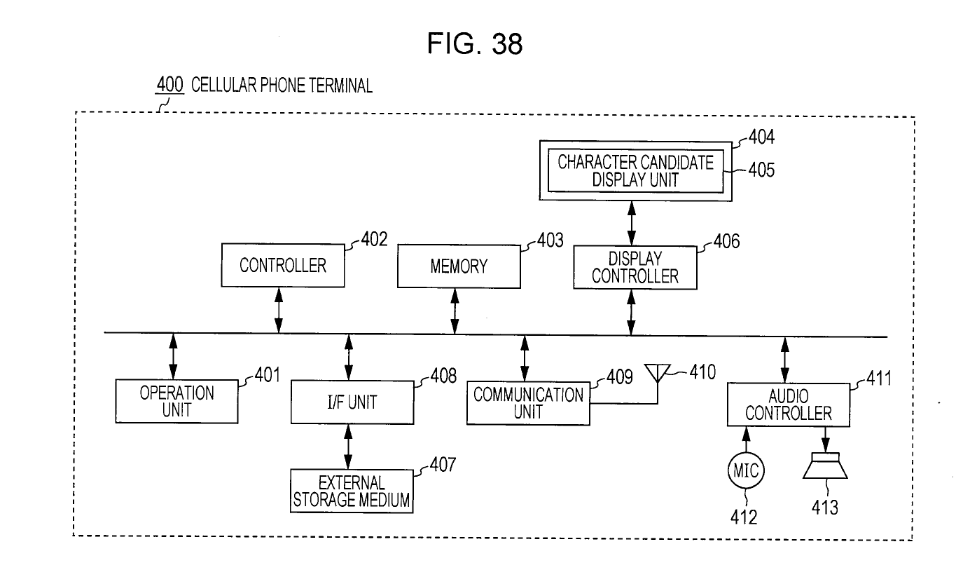

FIG. 38 shows an example of an internal configuration of the cellular phone terminal 400. The cellular phone terminal 400 includes the operation unit 401, a controller 402, the memory 403, the display unit 404, the character candidate display unit 405, a display controller 406, an external storage medium 407, an I/F unit 408, a communication unit 409, an antenna 410, an audio controller 411, a microphone 412, and a speaker 413.

The operation unit 401, the display unit 404, and the character candidate display unit 405 have been described above, and therefore, descriptions thereof are omitted. The controller 402 includes a CPU (Central Processing Unit) and the like, and the memory 403 includes a ROM (Read Only Memory) or a RAM (Random Access Memory). The controller 402 performs various processes in accordance with programs stored in the memory 403 or programs read to the memory 403 from the external storage medium 407. For example, when a user instructs for generation of an electric mail (hereinafter simply referred to as a “mail”), the display controller 406 is controlled so that a text generation screen is displayed in the display unit 404. The memory 403 also stores data required for executions of the various processes performed by the controller 402.

The display controller 406 controls display of an electric-mail generation screen and display of Web pages and controls output of characters, symbols, images, and the like to the display unit 404 and the character candidate display unit 405. The external storage medium 407 is attachable to the cellular phone terminal 400 through the I/F unit 408, and is constituted by a USB (Universal Serial Bus) memory or a memory card, for example.

The antenna 410 receives electric waves transmitted from base stations and outputs the electric waves to the communication unit 409. The communication unit 409 performs demodulation of the electric waves received by the antenna 410 and modulation of data in the cellular phone terminal. The microphone 412 obtains sound around the cellular phone terminal 400 and voice of the user and converts the sound and the voice into audio signals. The speaker 413 outputs audio read from the memory 403 and audio obtained by the communication unit 409 and the like. The audio controller 411 performs a process of demodulating the audio transmitted from the communication unit 409 and the audio obtained by the microphone 412 and a process of modulating audio signals to be output from the speaker 413.

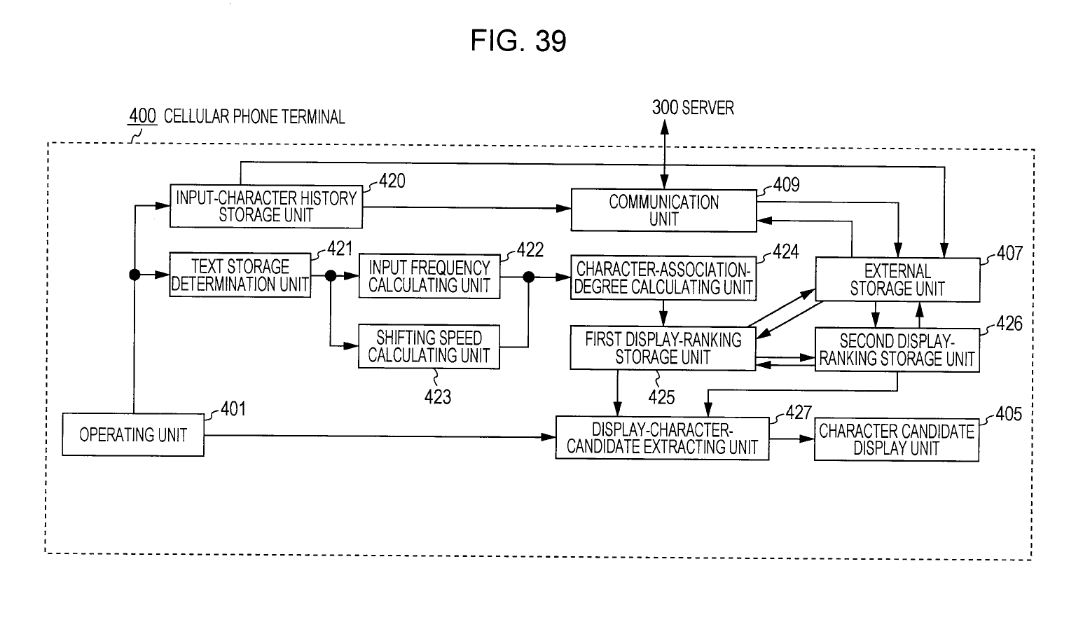

Next, operations of the units included in the cellular phone terminal 400 will be described with reference to a function block diagram shown in FIG. 39. The cellular phone terminal 400 include the operation unit 401, the character candidate display unit 405, the external storage medium 407, the communication unit 409, an input-character history storage unit 420, a character storage determination unit 421, an input-frequency calculating unit 422, an input-frequency calculating unit 422, a character-association-degree calculating unit 424 serving as a command-association-degree calculating unit, a first display-ranking storage unit 425, a second display-ranking storage unit 426, a display-character-candidate extracting unit 427 serving as a display command extracting unit.

The input-character history storage unit 420 is a region which stores an operation input history when the user inputs words. Information stored in the input-character history storage unit 420 is transmitted to the server 300, and the server 300 uses the information when classifying the user into a certain community. As operation history information, information on types of words input by the user, information on dates and times when the inputs of the words are terminated, and information on transmission destinations of mails.

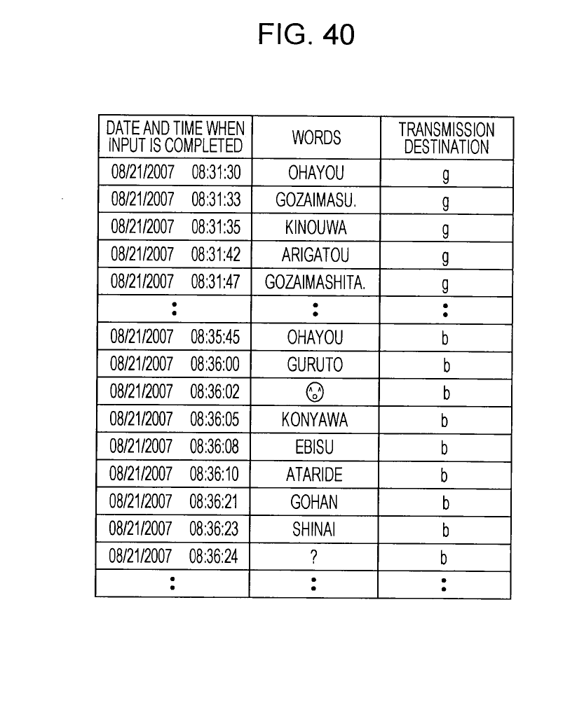

FIG. 40 shows an example of input-character history data stored in the input-character history storage unit 420. In a column of “date and time when input is completed”, dates and times, such as “Aug. 21, 2007 08:31:30”, when a user finished an input of words are included, and in an item “words” which is positioned on the right side of the column of “date and time when input is completed”, the input words, such as “ohayou”, are included. Furthermore, in an item “transmission destination” positioned on the right side of the item “words”, names of transmission destinations, such as “Mr. g”, are included as information on transmission destinations of a mail. The information stored in the input-character history storage unit 420 is transmitted to the server 300 through the communication unit 409 or the external storage medium 407.

The character storage determination unit 421 determines, when a command such as a character, a symbol, a phrase, or the like is input, whether an input preceding command corresponds to a symbol representing an end of a sentence such as a period, a space, a line break, or the like. When it is determined that the input preceding command corresponds to a symbol representing an end of a sentence, a currently-input command is not output. That is, the currently-input command is not used for calculation of a frequency between commands.

As described above, in a case where a command to be input corresponds to a character, a symbol, a phrase, or the like, even if a certain period of time has been elapsed from when a preceding command is input to when the next command is input, it is possible that a degree of an association between the preceding command and the next command is high. Accordingly, in this embodiment, a determination as to whether an input command is to be used for a calculation of an association degree is not made in accordance with a period of time elapsed from when a preceding command is input to when the next command is input but made in accordance with content of the input command.

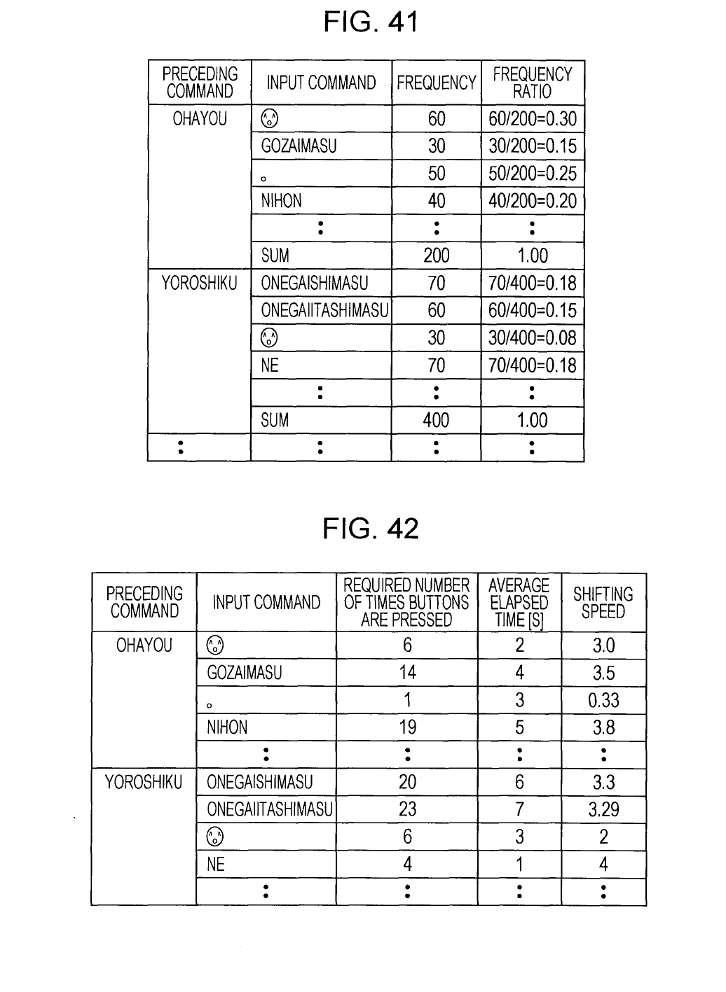

FIG. 41 shows an example of frequency ratios calculated by the input-frequency calculating unit 422. As shown in FIG. 20, after a command “ohayou” (a preceding command) is input, commands (input commands) “(̂ô)”, “gozaimasu”, “.”, “nihon” and so on are input, and after a command “yoroshiku” is input, commands “onegaishimasu”, “onegaiitashimasu”, “(̂ô)”, “ne” and so on are input.

In addition, frequencies and frequency ratios of combinations of “preceding commands” and “input commands” are shown. Methods for calculating the frequencies and the frequency ratios are the same as that performed by the input-frequency calculating unit 203 which has been described in the first embodiment. Assuming that a sum of frequencies of “input commands” which are associated with the command “ohayou” is 200, a frequency ratio obtained when the command “gozaimasu” is input after the command “ohayou” is 0.30, which is obtained by dividing a frequency of 60 of a combination of the command “ohayou” and the command “gozaimasu” by the sum 200.

FIG. 42 shows examples of shifting speeds of the combinations of “preceding commands” and “input commands” calculated by a shifting-speed calculating unit 423. In this embodiment, “the required number of times a button is pressed” means the minimum number of times a button is pressed required when an “input command” is input. In a case of the command “gozaimasu”, for example, the character input buttons 401IN should be pressed six times when a character “go” is to be input, the character input buttons 401IN should be pressed twice when a character “za” is to be input, the character input buttons 401IN should be pressed twice when a character “i” is input, the character input buttons 401IN should be pressed once when a character “ma” is input, and the character input buttons 401IN should be pressed three times when a character “su” is input. Then, a sum of these numbers, that is, 14, is set as a requisite minimum operation number. As for symbols and pictograms, an operation of moving a cursor to select a symbol or a pictogram is performed, and the number of operations required when the cursor is operated corresponds to the requisite minimum operation number.

Furthermore, an “average elapsed time” shown in FIG. 42 means an average of periods of time elapsed from when an input of a preceding command is completed to when an input of the next command is completed. A method for obtaining an average value of elapsed periods of time is the same as that described in the first embodiment. In FIG. 42, when a combination of the command “ohayou” corresponding to the “preceding command” and the command “gozaimasu” corresponding to the “input command” is taken as an example, the “required number of times a button is pressed” is 14 since the “required number of times a button is pressed” corresponds to the number of times a button is pressed for inputting the command “gozaimasu”. Furthermore, the “average elapsed time” is 4 seconds. Accordingly, the “shifting speed” is obtained as follows: 14/4=3.5.

FIG. 43 shows an example of a case where display ranks are determined by the character-association-degree calculating unit 424 in accordance with input frequencies and shifting speeds obtained as described above. When the case where the command “ohayou” corresponds to the “preceding command” and the command “gozaimasu” corresponds to the “input command” is taken as an example, an “association degree” of 0.90 is obtained by multiplying a frequency ratio of 0.30 obtained by the method described above by a shifting speed of 3.0. Furthermore, since a sum of association degrees of the “input commands” associated with the command “ohayou” is 2.0, an association degree ratio of 45.0 is obtained in this case by the following equation: 0.90/2.0*100=45.0.

The command “(̂ô)” has the highest association degree ratio of 45.0 to the command “ohayou” serving as the “preceding command” followed by the command “gozaimasu” having an association degree ratio of 26.5, the command “.” having an association degree ratio of 10.8, and the command “nihon” having an association degree ration of 6.5. Then, the display ranks are assigned in this order. The display ranks obtained as described above are output to and stored in the first display-ranking storage unit 425.

The second display-ranking storage unit 426 is a region which stores command display ranking and the like of other users and master users transmitted from the server 300. As with the second display-ranking storage unit 207 of the first embodiment, values of data stored in the second display-ranking storage unit 426 are not updated by a process performed by the character-association-degree calculating unit 424, for example. Therefore, if display ranking information to be stored is read from the first display-ranking storage unit 425 and is transferred to the second display-ranking storage unit 426, the display ranking information is retained without being updated.

The display-character-candidate extracting unit 427 sequentially extracts a predetermined number of “input commands”, from an “input command” having the highest display rank, among “input commands” in accordance with the display ranking information stored in the first display-ranking storage unit 426 and/or the second display-ranking storage unit 426, and outputs the extracted “input commands” to the character candidate display unit 405 included in the display unit 404.

FIG. 37 shows an example of a state in which words serving as input candidates are displayed in the character candidate display unit 405. In FIG. 37, “input commands” are displayed as characters in order of display rank in the display ranking information shown in FIG. 43. In the example shown in FIG. 43, the command “(̂ô)” has the highest display rank when the command “ohayou” corresponds to the “preceding command”, followed by the command “gozaimasu”, the command “.”, and the command “nihon” in this order. Then, the character candidate display unit 405 shown in FIG. 37 displays the characters in this order from an upper left of a screen. In FIG. 37, commands “san”, “guruto”, and “ssu” follow the command “nihon” since fifth to seventh display ranks are assigned to these characters. Display of these characters is omitted in FIG. 43.

Furthermore, also in this embodiment, as a criterion used by the server 300 for classifying users into communities, information on answers of questionnaires of the users are also utilized, and the information on answers of questionnaires is stored in the input-character history storage unit 420.

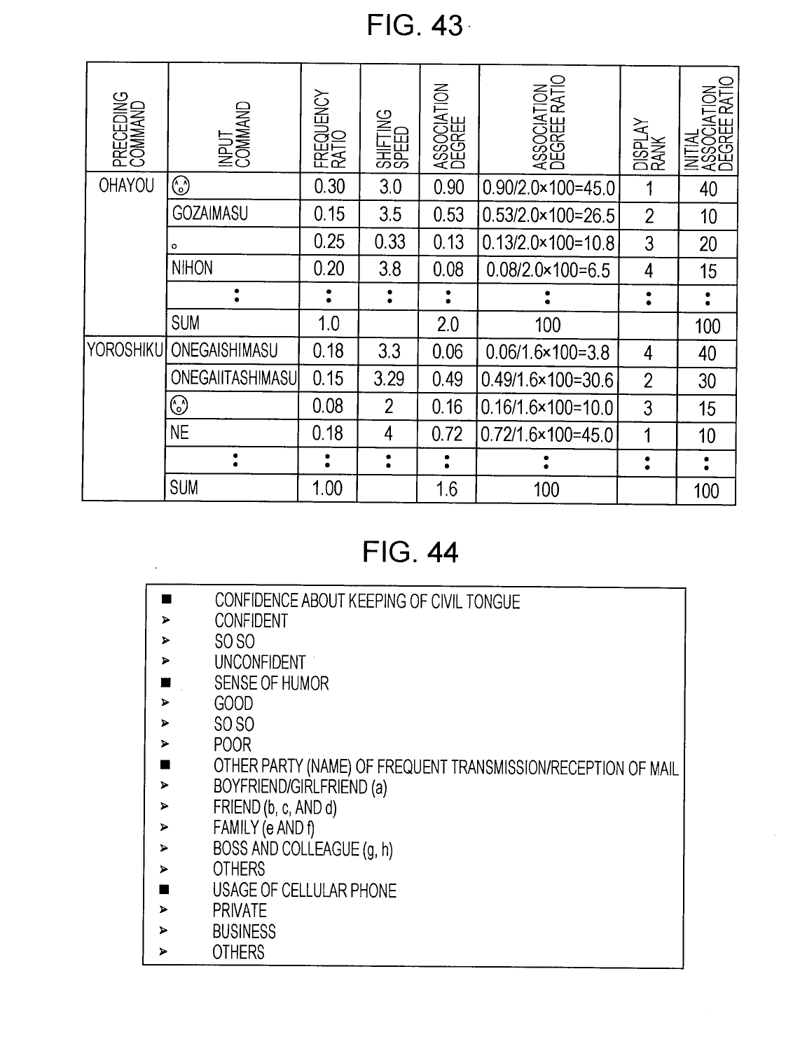

FIG. 44 shows an example of a configuration of a questionnaire. The questionnaire is displayed in the display unit 404 when the cellular phone terminal 400 is first turned on. The questionnaire shown in FIG. 44 includes items for obtaining information regarding quality of sentences generated by the user, such as items “confidence about keeping of civil tongue”, “sense of humor”, and the like, and items for obtaining information regarding usage, such as items “other party (name) of frequent transmission/reception of mail”, “usage of cellular phone”, and the like. For example, as for the item “confidence about keeping of civil tongue” among the items, one of options “confident”, “so so”, and “unconfident” is selected.

As for the item “other party (name) of frequent transmission/reception of mail”, in addition to options “boyfriend/girlfriend” and “friend”, an input of a name of the other party is also received. Note that the “other party” corresponds to the item “transmission destination” included in the input-character history data shown in FIG. 40. By associating the name of the transmission destination with the relationship between the transmission destination and the user such as “boyfriend/girlfriend” or “friend” in the questionnaire, the name of the transmission destination and information on the relationship which are associated with each other are stored in the server 300 which received the information on answers of questionnaire and the input-character history data.

Note that when information on property of the transmission destination is to be obtained as the input-character history information, an input of the name of the transmission destination in the questionnaire is not required. Alternatively, the item may be omitted.

A process of transmitting the information on answers of a questionnaire and the input-character history data to the server (or data is obtained) is similar to the process of the first embodiment described with reference to FIG. 25.

Next, processes performed by the various units included in the server 300 will be described in detail. Configurations of the units of the server 300 are the same as those of the units shown in the function block diagram of FIG. 26. A log data processor 310 processes the input-character history data received through a communication unit 304 so as to obtain data usable as a criterion for classification of the user into a certain community. The input-character history data transmitted from the user includes, as shown in FIG. 40, information on a type of a word input by the user, information on a date and time when the input of the word is terminated, and information on a transmission destination of a mail.

The log data processor 310 calculates frequencies of appearances of words in a period of time data has been stored, for individual words and for individual transmission destinations. Furthermore, the log data processor 310 calculates the number of total transmissions of mails in the period of time the data has been stored and the number of words per mail in accordance with information on the number of total words included in the individual mails.

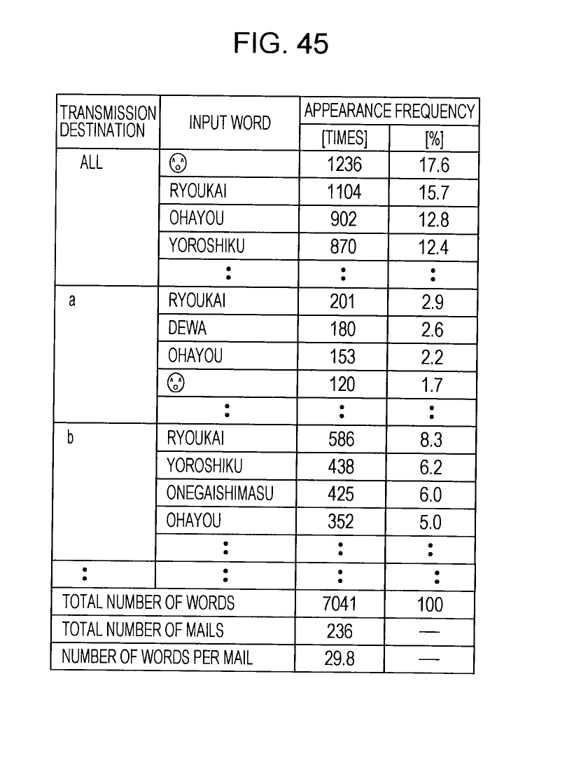

FIG. 45 shows an example of a result of the process performed by the log data processor 310. Items “transmission destination”, “input word”, and “appearance frequency” are described, and input words and appearance frequencies are described in descending order of values of the input words and the appearance frequencies for individual transmission destinations. When the item “transmission destination” corresponds to “all”, that is, a transmission destination is not specified, the word “(̂ô)” is the most frequently input, followed by words “ryoukai”, “ohayou”, and “yoroshiku” in this order.

Furthermore, the number of appearance frequencies of the words and ratios (%) of the appearance frequencies are shown. For example, the number of appearances of the word “(̂ô)” is 1236, and the appearance ratio thereof to the total number of words (7041) is 17.6%. When the item “transmission destination” corresponds to “a”, the word “ryokai” is the most frequently input by the user, and an appearance frequency thereof is 2.9%. Furthermore, when the item “transmission destination” corresponds to “b”, the word “ryoukai” is the most frequently input by the user, and an appearance frequency thereof is 8.3%. The log data processor 310 transmits the data obtained as described above to a user classifying unit 311 and a master-user extracting unit 313.

The user classifying unit 311 performs a process of classifying users serving as data transmission sources into communities in accordance with data transmitted from the log data processor 310. The classification is performed in accordance with the data calculated by the log data processor 310 and the information on answers of a questionnaire transmitted from the users.

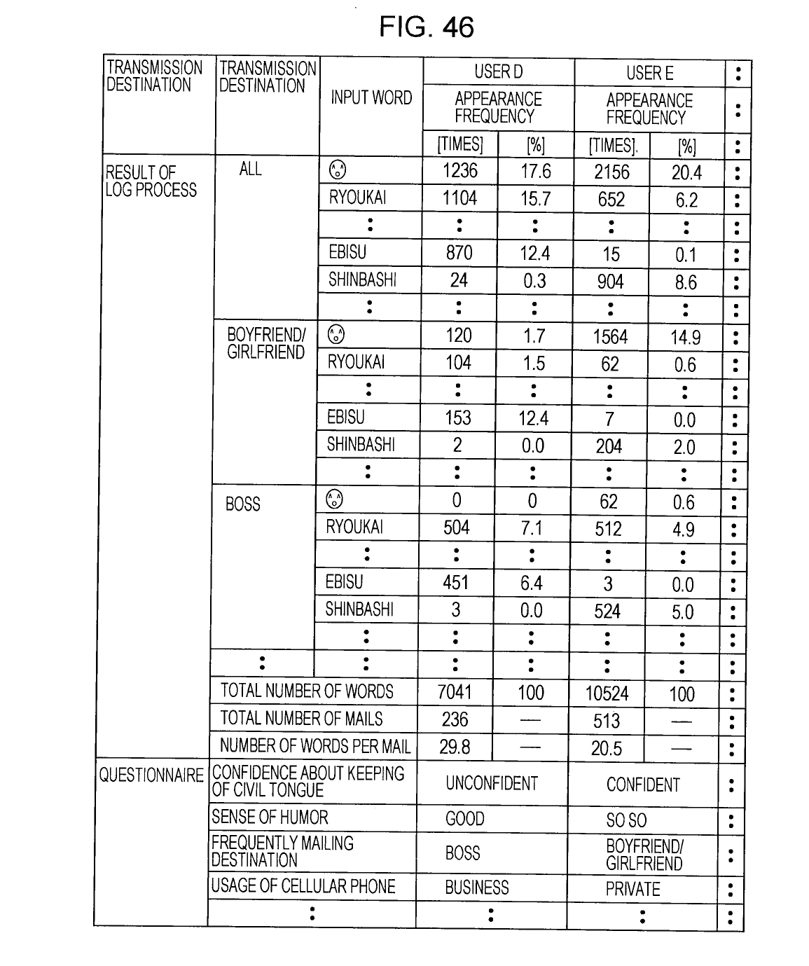

The user classifying unit 311 generates a table as shown in FIG. 46 in accordance with log-process result data transmitted from the log data processor 310 and the information on answers of a questionnaire. The table in FIG. 46 includes the log-process result data transmitted from the log data processor 310 and the information on answers of a questionnaire for individual users. The user classifying unit 311 performs the process of classifying users into communities using the elements included in the table as parameters.

FIG. 46 shows the information on answers of a questionnaire in addition to the information on the result of the process performed by the log data processor 310 which is shown in FIG. 45. For example, as for data of a user D, the word “(̂ô)” is the most frequently input by the user D, followed by the word “ryoukai”, a word “ebisu”, a word “shinbashi”, and the like. Then, when the transmission destination corresponds to “boyfriend/girlfriend”, an appearance frequency of the word “ebisu” is high, that is, 12.4%, and when the transmission destination corresponds to “boss”, an appearance frequency of the word “ryoukai” is high, that is, 7.1%. Furthermore, according to results of the questionnaire, it is recognized that the user D does not have confidence about keeping of civil tongue, has sense of humor, frequently transmits e-mails to “boss”, and uses a cellular phone for “business”.

The user classifying unit 311 generates, for example, communities for individual combinations of “transmission destinations” and “input words”, and performs the process of classifying users into the communities. Examples of communities generated in accordance with the parameters shown in FIG. 45 include a community “the word “ebisu” is frequently used when the transmission destination corresponds to a boyfriend/girlfriend” and a community “the word “ryoukai” is frequently used when the transmission destination is a boss”.

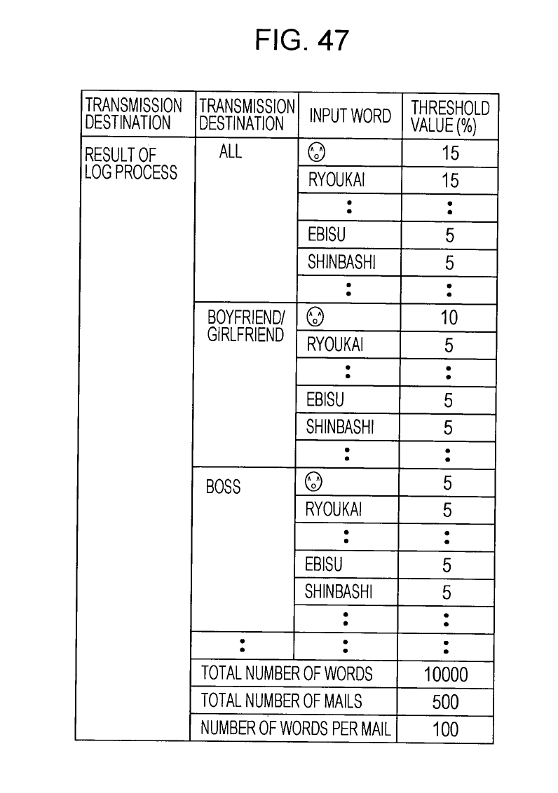

The user classifying unit 311 refers to values of appearance frequencies of input words in order to determine whether the words are “frequently-used” words. FIG. 47 shows an example of a setting of threshold values provided for individual appearance frequencies. FIG. 47 shows a state in which threshold values are set for individual combinations of “transmission destinations” and “input words”. The threshold values are set so as to correspond to the appearance frequencies of “input words”. When the “transmission destination” corresponds to “all”, 15% is set for the words “(̂ô)” and “ryoukai” and 5% is set for the words “ebisu” and “shinbashi”. Furthermore, when the “transmission destination” corresponds to “boyfriend/girlfriend”, 10% is set for the word “(̂ô)” and 5% is set for the words “ryoukai”, “ebisu” and “shinbashi”. Moreover, when “transmission destination” corresponds to “boss”, 5% is set for the words “(̂ô)”, “ryoukai”, “ebisu” and “shinbashi”.

It is recognized that, in a case of the user D shown in FIG. 46, combinations having values larger than the threshold values shown in FIG. 47 correspond to a combination of “all” serving as the “transmission destination” and the word “(̂ô)”, a combination of “all” serving as the “transmission destination” and the word “ryoukai”, a combination of “all” serving as the “transmission destination” and the word “ebisu”, a combination of “boyfriend/girlfriend” serving as the “transmission destination” and the word “ebisu”, a combination of “boss” serving as the “transmission destination” and the word “ryoukai”, and a combination of “boss” serving as the “transmission destination” and the word “ebisu”. Therefore, the user D is classified into a community “pictograms are frequently used (irrespective of a transmission destination)”, a community “a word “ryoukai” is frequently used (irrespective of a transmission destination)”, a community “a word “ebisu” is frequently used (irrespective of a transmission destination)”, a community “pictograms are frequently used when a transmission destination corresponds to a boyfriend/girlfriend”, a community “a word “ryoukai” is frequently used when a transmission destination corresponds to a boss”, and a community “a word “ebisu” is frequently used when a transmission destination corresponds to a boss”.

Although an example of a case where community classification is performed using combinations of “transmission destinations” and “input words” in FIG. 47, a community “confidence about keeping of civil tongue”, a community “cellular phone is used for business”, and the like may be generated in accordance with the information on answers of a questionnaire.

Alternatively, communities may be generated by a combination of the log data and the parameters of the information on answers of a questionnaire. For example, a community “pictograms are frequently used and a word “ebisu” is frequently used for a boyfriend/girlfriend”, a community “confidence about keeping of civil tongue, a word “shinbashi” is frequently used, and a cellular phone is used for business”, and the like may be generated.

The community-display-ranking calculating unit 312 performs a process of calculating display ranks in an entire community in accordance with display ranking information of users who belong to the community. Detailed operations of the process are the same as those described with reference to FIGS. 31 and 30. The master-user extracting unit 313 also performs a process which is substantially the same as that described in the first embodiment. Specifically, the master-user extracting unit 313 performs a process of reading display ranking information of master users stored in the master-user-list storage unit 314 and extracting users in the community whose operation histories are remarkable.

Examples of the master users in this embodiment include a person who uses proper Japanese, a person who fluently uses buzzwords such as words used by people in specific ages such as youngsters (for example, young women called “gals”), and a person who makes humorous sentences well. Specifically, examples of the master users include a specialist of Japanese language, an instructor of business manner training, and a person who speaks words which are unique to youngsters (so-called “gal words”). Furthermore, examples of users whose operation histories are remarkable include a user who sent the largest number of mails in a predetermined period of time, a user who uses the largest number of words per mail, and a user who sent the largest number of mails to a person who has the specific relationship with the user, such as a boyfriend/girlfriend.

The master-user extracting unit 313 outputs the display ranking information of the extracted master users to the community-display-ranking storage unit 315. Then, the community-display-ranking storage unit 315 associates the community display ranking information transmitted from the community-display-ranking calculating unit 312 and the display ranking information of the master users transmitted from the master-user extracting unit 313 with the user and stores them.

The display ranking information stored in the community-display-ranking storage unit 315 is transmitted to the cellular phone terminal 400 through the communication unit 304. In the cellular phone terminal 400, the display ranking information transmitted from the server 300 is stored in the second display-ranking storage unit 426. Then, the information is referred to in accordance with an instruction issued by a user when the display-character-candidate extracting unit 427 extracts character candidates.

By performing this operation, display ranking information of a community into which a user is classified and display ranking information of the master users are provided for the user. Furthermore, also in this embodiment, an item “list obtaining” is provided in a menu of the cellular phone terminal 400, and the user appropriately obtains desired display ranking information.

According to the configuration and the processes of this embodiment described above, display ranking information generated in accordance with operation histories of users in a community to which the user belongs whose operation histories are remarkable or famous people such as a specialist of Japanese language is provided. Accordingly, the user notices expressions and phrases in which the user has never thought of, and furthermore, the user may use the expressions and the phrases.

In this case, when the user performs a setting so as to use the display ranking information supplied from the server 300, character candidates are displayed so as to correspond to characters input by the user in the character candidate display unit 405 of the cellular phone terminal 400. By this, the user may learn information on specific usage of endings of sentences, information on positions of insertion of punctuation marks, information on words to be selected at appropriate timings, and may use them.

Furthermore, according to the configuration of this embodiment described above, the user may obtain display ranking information of a desired community among various communities included in the server 300. Accordingly, when a junior high-school student who likes to be a “gal” obtains display ranking information of a person who uses “gal words” registered as a master user, the student may effectively learn the “gal words”.

Note that, in the foregoing embodiments, the cases where the information signal processing apparatus is applied to the remote control apparatus and the cellular phone terminal are taken as examples. However, the information signal processing apparatus may be applied to other apparatuses including a mobile terminal such as a PDA (Personal Digital Assistants) and a word processor.

Furthermore, a series of processes of each of the foregoing embodiments described above may be executed by hardware or software. When the series of processes is executed by software, programs included in the software are installed in a computer incorporated in dedicated hardware or a general personal computer capable of executing various functions by installing various programs.

### EXPLANATION OF REFERENCE NUMERALS

2L, 2R DISPLAY UNIT, 10 OPERATION UNIT, 10KY ARROW KEY, 10XA ENTER BUTTON, 10XB BACK BUTTON, 10XD DOWN BUTTON, 10XL LEFT BUTTON, 10XR RIGHT BUTTON, 10XU UP BUTTON, 11 CONTROLLER, 12 MEMORY, 13 REMOTE CONTROL SIGNAL GENERATING UNIT, 14 REMOTE CONTROL SIGNAL TRANSMISSION UNIT, 15 DISPLAY UNIT, 16 DISPLAY CONTROLLER, 17 COMMAND DISPLAY/INPUT UNIT, 17a, 17b, AND 17c COMMAND DISPLAY INPUT BUTTONS, 18 EXTERNAL STORAGE MEDIUM, 18 MEMORY, 19 I/F UNIT, 20 REMOTE CONTROL DEVICE, 26 FIRST DISPLAY-RANKING STORAGE UNIT, 40 REPRODUCTION SPEED DETERMINATION UNIT, 50 NETWORK, 61 CHARACTER INFORMATION EXTRACTING UNIT, 100 REPRODUCING DEVICE, 101 CONTROLLER, 102 MEMORY, 103 DECODER, 104 COMMUNICATION UNIT, 105 DISPLAY UNIT, 106 DISPLAY CONTROLLER, 107 EXTERNAL STORAGE MEDIUM, 108 I/F UNIT, 109 SIGNAL RECEIVING UNIT, 180 EXTERNAL STORAGE MEDIUM, 200 REMOTE CONTROL DEVICE, 201 OPERATION HISTORY STORAGE UNIT, 202 COMMAND STORAGE DETERMINATION UNIT, 203 INPUT-FREQUENCY CALCULATING UNIT, 204 SHIFTING-SPEED CALCULATING UNIT, 205 COMMAND-ASSOCIATION-DEGREE CALCULATING UNIT, 206 FIRST DISPLAY-RANKING STORAGE UNIT, 207 SECOND DISPLAY-RANKING STORAGE UNIT, 208 DISPLAY-COMMAND EXTRACTING UNIT, 300 SERVER, 301 CONTROLLER, 302 MEMORY, 303 STORAGE UNIT, 304 COMMUNICATION UNIT, 310 LOG DATA PROCESSOR, 311 USER CLASSIFYING UNIT, 312 COMMUNITY-DISPLAY-RANKING CALCULATING UNIT, 313 MASTER-USER EXTRACTING UNIT, 314 MASTER-USER-LIST STORAGE UNIT, 315 COMMUNITY-DISPLAY-RANKING STORAGE UNIT, 400 CELLULAR PHONE TERMINAL, 401 OPERATION UNIT, 402 CONTROLLER, 403 MEMORY, 404 DISPLAY UNIT, 405 CHARACTER CANDIDATE DISPLAY UNIT, 406 DISPLAY CONTROLLER, 407 EXTERNAL STORAGE MEDIUM, 408 I/F UNIT, 409 COMMUNICATION UNIT, 410 ANTENNA, 411 AUDIO CONTROLLER, 412 MICROPHONE, 413 SPEAKER, 420 INPUT-CHARACTER HISTORY STORAGE UNIT, 421 CHARACTER STORAGE DETERMINATION UNIT, 422 INPUT-FREQUENCY CALCULATING UNIT, 423 SHIFTING-SPEED CALCULATING UNIT, 424 CHARACTER-ASSOCIATION-DEGREE CALCULATING UNIT, 425 FIRST DISPLAY-RANKING STORAGE UNIT, 426 SECOND DISPLAY-RANKING STORAGE UNIT, 427 DISPLAY-CHARACTER-CANDIDATE EXTRACTING UNIT, A, B, C, AND D USER, Ar1 REGION, C1 COMMAND, CS1 AND CS10 CURSOR, EX1 MASTER, EX2 MASTER USER, KY ARROW KEY, MN1 AND MN10 MENU SCREEN, XY COMMUNITY, XA ENTER BUTTON, XB BUTTON, XD DOWN BUTTON, XL LEFT BUTTON, XR RIGHT BUTTON, XU UP BUTTON

1. An information presentation system including an information signal processing apparatus having a plurality of commands corresponding to a plurality of functions and a server which performs data communication with the information signal processing apparatus, wherein
the information signal processing apparatus includes
an operation unit which accepts operation inputs and generates signals in accordance with a number of the commands selected by the operation input,
a command display/input unit which is included in the operation unit, which displays text blocks corresponding to the commands, and which generates and outputs signals corresponding to the commands when accepting the selection operations of the commands corresponding to the text blocks,
an operation history storage unit which stores content of the operation inputs performed using the operation unit so as to generate operation history information,
a command association degree calculating unit which calculates degrees of associations between first commands in which selection operations thereof were accepted last time and second commands which are selected by the operation inputs using the operation unit for individual combinations of the first commands and the second commands, and which assigns ranks to the second commands associated with the first commands in order of degrees of the associations with the first commands so as to generate first display ranking information,
an input/output unit which outputs the operation history information stored in the operation history storage unit and the first display ranking information to the server and receives second display ranking information output from the server, and
a display-command extracting unit which selects one of the first commands of a type the same as the command selected by the input operation using the operation unit from at least one of display ranking information selected by a user from among the first display ranking information and the second display ranking information, which extracts a predetermined number of second commands which are associated with the selected first command in the display ranking information in order of degrees of associations with the first command, and which outputs the extracted second commands,
the server includes
a user classifying unit which classifies the user of the information signal processing apparatus into one of communities which are groups generated for individual types of the operation history information in accordance with the operation history information output from the information signal processing apparatus,
a community display ranking calculating unit which generates the second display ranking information for individual communities into which users are classified in accordance with display ranking information transmitted from all the users classified into the communities, and
an outputting unit which outputs the second display ranking information calculated by the community calculating unit to the information signal processing apparatus, and
the command display/input unit of the information processing apparatus displays text blocks corresponding to a predetermined number of second commands output from the display command extracting unit in order of the ranks assigned to the second commands.

2. The information presentation system according to claim 1, wherein
the community display ranking calculating unit included in the server generates the second ranking information by adding the ranks assigned to the second commands in the display ranking information transmitted from all the users classified into the communities to one another for individual combinations of the first commands and the second commands so as to obtain sums of the ranks, and assigning new ranks in an order from the smallest value of the sum.

3. The information presentation system according to claim 2, wherein
the server includes
a specific-user display ranking information storage unit which stores display ranking information calculated in accordance with information on a specific user whose operations are likely to be used as a reference for the user and display ranking information calculated in accordance with operation history information of the specific user,
a community display ranking storage unit which stores the second display ranking information calculated by the community display ranking calculating unit and the display ranking information of the specific user stored in the specific-user display ranking information storage unit, and
a community display ranking storage unit which adds the display ranking information of the specific user to the second display ranking information and outputs resultant information to the output unit.

4. The information presentation system according to claim 3, wherein
the server includes a specific-user extracting unit which extracts, from among the operation history information output from the information signal processing apparatus, operation history information including an operation history having a certain characteristic and which stores a user of the information signal processing apparatus serving as a transmission source of the extracted operation history information as the specific user.

5. The information presentation system according to claim 4, wherein
the server includes a log data processor which obtains statistics of the operation history information output from the information signal processing apparatus and which outputs a result of the statistics to the user classifying unit.

6. The information presentation system according to claim 5, wherein
the operation history information stored in the operation history storage unit of the information signal processing apparatus includes information on starting times of operations performed using the operation unit so that the commands are generated, information on ending times of the operations, and information on types of the commands generated in accordance with the operations, and
the log data processor of the server calculates an operation periods in which the operation is performed and frequency of the operation in accordance with the operation history information output from the information signal processing apparatus, and obtains statistics of the operation history information by calculating operation amounts by integrating the calculated operation periods and the number of operations.

7. The information presentation system according to claim 6, wherein
the specific-user extracting unit of the server focuses the maximum value among values of operation frequencies, the maximum value among values of operation periods, and the maximum value among values of operation amounts calculated by the log data processor and extracts a user of the information signal processing apparatus which outputs the operation history information serving as source data of the maximum values as the specific user.

8. The information presentation system according to claim 6, wherein
the log data processor of the server calculates the operation periods, the operation frequencies, the operation amounts for types of the second commands, and
the user classifying unit of the server classifies, on the basis of a type of one of the second commands which has the largest value of an operation amount calculated by the log data processor and the value of the operation amount, the user into one of the communities grouped in accordance with the types of the second commands and the values of the operation amounts.

9. The information presentation system according to claim 5, wherein
the user classifying unit of the server classifies, on the basis of information on results of questionnaires answered by the users and results of calculations performed by the log data processor, the users into the communities grouped in accordance with the information on results of questionnaires and the results of calculations performed by the log data processor.

10. The information presentation system according to claim 9, wherein
the operation history information stored in the operation history storage unit of the information signal processing apparatus includes information on values set to the commands in accordance with operation inputs performed by the users,
the log data processor of the server calculates average values of the set values for the types of the commands, and
the community display ranking calculating unit of the server calculates set values in the communities in accordance with the set values calculated for the types of the commands, and outputs the set values in the communities and corresponding types of commands to the community display ranking storage unit.

11. The information presentation system according to claim 4, wherein
the information signal processing apparatus includes a controller which performs a process of outputting, when an operation signal for obtaining a list of the second display ranking information stored in the community display ranking storage unit of the server is output from the operation unit in response to the operation input performed by the user, a request for obtaining a list of the display ranking information to the input/output unit, outputting a display control signal used to display the list of the display ranking information output from the server in response to the request for obtaining the list of the display ranking information, outputting, when certain display ranking information is selected from the list of the display ranking information in accordance with an operation input performed by the user, a request for obtaining the certain display ranking information to the input/output unit, and performing a storing process such that the display ranking information output from the server in response to the request for obtaining the certain display ranking information is stored as the second display ranking information.

12. The information presentation system according to claim 5, wherein
the first commands and the second commands include characters or symbols,
the operation history information stored in the operation history storage unit of the information signal processing apparatus includes information on time points when inputs of the second commands are terminated, information on the types of the second commands, and information on transmission destinations of the commands, and
the log data processor of the server obtains statistics of the operation history information by calculating appearance frequencies of the second commands for types of the transmission destinations of the commands in accordance with the operation history information output from the information signal processing apparatus.

13. The information presentation system according to claim 11, wherein
the transmission destinations of the commands correspond to transmission destinations of electric mails,
the log data processor of the server calculates the total number of transmissions of electric mails from the users, the number of transmissions of electric mails for individual transmission destinations of the electric mails, and the number of commands per electric mail, and
the specific-user extracting unit of the server extracts one of the users having the maximum number among the total number of transmissions of electric mails from the users, the number of transmissions of electric mails for individual transmission destinations of the electric mails, and the number of commands per electric mail as the specific user.

14. The information presentation system according to claim 13, wherein
the user classifying unit of the server classifies, in accordance with levels of the appearance frequencies of the second commands, the users into communities grouped in accordance with the transmission destinations of the commands and the types of the second commands.

15. An information signal processing apparatus which has a plurality of commands corresponding to a plurality of functions and which performs data communication with a server, the information signal processing apparatus comprising:
an operation unit which accepts operation inputs and generates signals in accordance with a number of the commands selected by the operation input,
a command display/input unit which is included in the operation unit, which displays text blocks corresponding to the commands, and which generates and outputs signals corresponding to the commands when accepting the selection operations of the commands corresponding to the text blocks,
an operation history storage unit which stores content of the operation inputs performed using the operation unit so as to generate operation history information,
a command association degree calculating unit which calculates degrees of associations between first commands in which selection operations thereof were accepted last time and second commands which are selected by the operation inputs using the operation unit for individual combinations of the first commands and the second commands, and which assigns ranks to the second commands associated with the first commands in order of degrees of the associations with the first commands so as to generate first display ranking information,
an input/output unit which outputs the operation history information stored in the operation history storage unit and the first display ranking information to the server and receives second display ranking information output from the server, and
a display-command extracting unit which selects one of the first commands of a type the same as the command selected by the input operation using the operation unit from at least one of display ranking information selected by a user from among the first display ranking information and the second display ranking information, which extracts a predetermined number of second commands which are associated with the selected first command in the display ranking information in order of degrees of associations with the first command, and which outputs the extracted second commands,
wherein the command display/input unit displays the text blocks corresponding to the predetermined number of second commands output from the display command extracting unit in order of the ranks assigned to the second command.

16. The information signal processing apparatus according to claim 15, comprising:
a first display ranking information storage unit which stores the display ranking information calculated by the command association degree calculating unit; and
a second display ranking information storage unit which stores the second display ranking information output from the server,
wherein the command association degree calculating unit outputs calculated display ranking information only to the first display ranking information storage unit.

17. The information signal processing apparatus according to claim 16, comprising:
an input-frequency calculating unit which calculates frequencies of consecutive input of the first command and the second command in terms of time; and
a shifting speed calculating unit which calculates shifting speeds between commands in accordance with the number of operations and speeds of operations performed by the operation unit required by the time the second command is input after a selection of the first command is cancelled,
wherein the command association degree calculating unit calculates degrees of associations between the first commands and the second commands in accordance with values obtained through addition of the input frequencies calculated by the input frequency calculating unit and the shifting speeds calculated by the shifting speed calculating unit.

18. The information signal processing apparatus according to claim 17,
wherein the command association degree calculating unit adds the calculated degrees of associations between the first commands and the second commands to one another for types of the first commands so as to obtains a total sum of the association degrees, calculates ratios of the association degrees to the total sum by dividing the association degrees by the total sum, and assigns ranks in an order from the highest ratio obtained by the calculation.

19. The information signal processing apparatus according to claim 8, wherein the commands include characters and symbols.

20. An information signal processing method employed in an information signal processing apparatus which performs data communication with a server, the information signal processing method comprising steps of:
accepting operation inputs and generating signals in accordance with a number of the commands selected by the operation input,
storing content of the operation inputs so as to generate operation history information,
calculating degrees of associations between first commands in which selection operations thereof were accepted last time and second commands which are selected by the operation inputs using the operation unit for individual combinations of the first commands and the second commands, and assigning ranks to the second commands associated with the first commands in order of degrees of the associations with the first commands so as to generate first display ranking information,
outputting the operation history information stored and the first display ranking information to the server and receiving second display ranking information generated by the server in accordance with the operation history information and the first display ranking information,
selecting one of the first commands of a type the same as the command selected by the input operation using the operation unit from at least one of display ranking information selected by a user from among the first display ranking information and the second display ranking information, extracting a predetermined number of second commands which are associated with the selected first command in the display ranking information in order of degrees of associations with the first command, and outputting the extracted second commands, and
displaying text blocks corresponding to the outputted predetermined number of second commands in order of the ranks assigned to the second commands, and generating, when an operation of selecting the displayed commands is received, a signal corresponding to the command is generated and output.

21. A computer readable recording medium
which records data used to display text blocks regarding a plurality of commands corresponding to a plurality of functions of a computer in a predetermined region in accordance with display ranks assigned to the commands, and
which has data configuration including information on correspondences between a first command which has been selected by a user and a plurality of second commands which are determined to have high degrees of associations with the first command in accordance with command selection operation history information of the user and information on ranks assigned to the second commands in order of the degrees of the associations with the first command.
